(19) United States
(12) Patent Application Publication
(10) Pub. No.: US 2012/0075420 A1
(43) Pub. Date: Mar. 29, 2012

(54) METHOD AND APPARATUS FOR GENERATING DATASTREAM FOR DISPLAYING THREE-DIMENSIONAL USER RECOGNITION INFORMATION, AND METHOD AND APPARATUS FOR REPRODUCING THE DATASTREAM

(75) Inventors: Bong-je CHO, Suwon-si (KR); Kil-soo JUNG, Osan-si (KR); Jae-seung KIM, Yongin-si (KR); Hong-seok PARK, Anyang-si (KR)

(73) Assignee: SAMSUNG ELECTRONICS CO., LTD., Suwon-si (KR)

(21) Appl. No.: 13/244,338

(22) Filed: Sep. 24, 2011

(30) Foreign Application Priority Data
Sep. 28, 2010 (KR) 10-2010-0093799

(51) Int. Cl. H04N 13/00

(52) U.S. Cl. 348/43; 348/E13.002

(57) ABSTRACT

A method of generating a datastream including two-dimensional (2D) video content or three-dimensional (3D) video content includes: inserting video data of the 2D video content or the 3D video content into the datastream; inserting into the datastream recognition information insertion information indicating whether 3D user recognition information including a mark used for a user to recognize that a 3D video is being reproduced is inserted in the datastream and display rights information indicating whether displaying of 3D user recognition information unique to a reproduction device is authorized; and transmitting the datastream.

### CROSS-REFERENCE TO RELATED PATENT APPLICATION

This application claims priority from Korean Patent Application No. 10-2010-0093799, filed on Sep. 28, 2010, in the Korean Intellectual Property Office, the disclosure of which is incorporated herein in its entirety by reference.

### BACKGROUND

1. Field

Methods and apparatuses consistent with exemplary embodiments relate to the generation of a video datastream including three-dimensional (3D) video content and the reproduction of the video datastream.

2. Description of the Related Art

As the use of 3D video display apparatuses and 3D video content have considerably increased, more users have the possibility to watch 3D video content. 3D video content is generally reproduced by using depth perception or a variation between images at different time points. Thus, a user may feel tired while watching 3D video content, and in particular, when a sudden change occurs between a 2D reproduction mode for reproducing 2D video content and a 3D reproduction mode for reproducing 3D video content.

Therefore, a display apparatus capable of operating in both a 2D reproduction mode and a 3D reproduction mode may display recognition information indicating whether the display apparatus operates in the 2D reproduction mode or the 3D reproduction mode, together with video content on a screen so that a user can more comfortably enjoy 3D content. Thus, the need for recognition information for giving advanced notice that the 2D reproduction mode is going to be changed to the 3D reproduction mode or that the 3D reproduction mode is going to be changed to the 2D reproduction mode which is displayed on the screen together with the video content.

### SUMMARY

According to an aspect of an exemplary embodiment, there is provided a method of generating a datastream including 2D video content or 3D video content, the method including: inserting video data of the 2D video content or the 3D video content into the datastream; inserting into the datastream recognition information insertion information indicating whether 3D user recognition information including a mark used for a user to recognize that a 3D video is being reproduced is inserted in the datastream and display rights information indicating whether displaying of 3D user recognition information unique to a reproduction device is authorized; and transmitting the datastream.

The inserting of the recognition information insertion information and the display rights information may include inserting the recognition information insertion information and the display rights information into one of a Transport Stream (TS) packet, a Packetized Elementary Stream (PES) packet, and an Elementary Stream (ES) of the datastream.

According to another aspect of an exemplary embodiment, there is provided a method of reproducing a datastream, the method including: receiving and parsing a datastream including video data of 2D video content or 3D video content; extracting from the datastream recognition information insertion information indicating whether 3D user recognition information including a mark used for a user to recognize that a 3D video is being reproduced is inserted in the datastream and display rights information indicating whether displaying of 3D user recognition information unique to an external reproduction device and a display device is authorized; extracting the video data from the parsed datastream; and displaying by one of the external reproduction device and the display device one of the 3D user recognition information and the unique 3D user recognition information on the video content based on the extracted recognition information insertion information and display rights information.

The recognition information insertion information and the display rights information may be extracted from one of a Transport Stream (TS) packet, a Packetized Elementary Stream (PES) packet, and an Elementary Stream (ES) of the datastream.

The displaying of the 3D user recognition information may include: confirming based on the recognition information insertion information that the 3D user recognition information provided by a provider of the video content is not inserted in the datastream and confirming based on the display rights information that displaying of the unique 3D user recognition information on the video content is authorized to the external reproduction device and the display device; determining priority of rights of displaying the unique 3D user recognition information on the video content between the external reproduction device and the display device; and outputting a video stream on which the 3D user recognition information is displayed, based on the priority of display rights between the external reproduction device and the display device.

According to another aspect of an exemplary embodiment, there is provided an apparatus for generating a datastream including 2D video content or 3D video content, the apparatus including: a video data inserter which inserts video data of the 2D video content or the 3D video content into the datastream; a 3D user recognition information inserter which inserts into the datastream 3D user recognition information including a mark used for a user to recognize that a 3D video is being reproduced; a recognition information related information inserter which inserts, into the datastream, recognition information insertion information indicating whether the 3D user recognition information is inserted in the datastream and display rights information indicating whether displaying of 3D user recognition information unique to a reproduction device is authorized; and a transmitter which transmits the datastream.

According to another aspect of the exemplary embodiments, there is provided an apparatus for reproducing a datastream, the apparatus including: a receiver which receives and parses a datastream including video data of 2D video content or 3D video content; a recognition information related information extractor which extracts from the datastream recognition information insertion information indicating whether 3D user recognition information including a mark used for a user to recognize that a 3D video is being reproduced is inserted in the datastream and display rights information indicating whether displaying of 3D user recognition information unique to an external reproduction device and a display device is authorized; a 3D user recognition information extractor which extracts the 3D user recognition information from the datastream based on the recognition information insertion information; a video data extractor which extracts the video data from the parsed datastream; and an output unit which displays via one of the external reproduction device and the display device one of the 3D user recognition information and the unique 3D user recognition information on the video content based on the extracted recognition information insertion information and display rights information.

The external reproduction device and the display device may include a priority determiner which determines priority of rights of displaying the unique 3D user recognition information on the video content between the external reproduction device and the display device if it is confirmed based on the recognition information insertion information that the 3D user recognition information provided by a provider of the video content is not inserted in the datastream and it is confirmed based on the display rights information that displaying of the unique 3D user recognition information on the video content is authorized to the external reproduction device and the display device, and the output unit may output a video stream on which the 3D user recognition information is displayed, based on the priority of display rights between the external reproduction device and the display device.

According to another aspect of an exemplary embodiment, there is provided an apparatus for reproducing a datastream, the apparatus including: a receiver which receives and parses a datastream including video data of 2D video content or 3D video content; a recognition information related information extractor which extracts, from the datastream, recognition information insertion information indicating whether 3D user recognition information including a mark used for a user to recognize that 3D video is being reproduced is inserted in the datastream and display rights information indicating whether displaying of 3D user recognition information unique to an external reproduction device and a display device is authorized; a 3D user recognition information extractor which extracts the 3D user recognition information from the datastream based on the recognition information insertion information; a video data extractor which extracts the video data from the parsed datastream; and an output unit which displays, via the display device, one of the 3D user recognition information and the unique 3D user recognition information on the video content based on the extracted recognition information insertion information and display rights information.

According to another aspect of an exemplary embodiment, there is provided a non-transitory computer readable recording medium having recorded thereon a computer readable program for executing the method of generating a datastream.

According to another aspect of an exemplary embodiment, there is provided a non-transitory computer readable recording medium having recorded thereon a computer readable program for executing the method of reproducing a datastream.

### BRIEF DESCRIPTION OF THE DRAWINGS

The above and/or other features and advantages of the aspects of the exemplary embodiments will become more apparent by describing in detail the exemplary embodiments thereof with reference to the attached drawings in which:

FIG. 1 is a block diagram of a datastream generating apparatus for displaying 3D user recognition information according to an exemplary embodiment;

FIG. 2 is a block diagram of a datastream reproducing apparatus for displaying 3D user recognition information according to an exemplary embodiment;

FIG. 3 is a block diagram of another datastream reproducing apparatus for displaying 3D user recognition information according to an exemplary embodiment;

FIGS. 4 to 6 illustrate 3D user recognition information provided together with video content by a content provider, according to exemplary embodiments;

FIGS. 7A, 7B and 7C illustrate 3D user recognition information displayed on video content by a content provider according to 3D video formats for only 3D reproduction, respectively, according to exemplary embodiments;

FIG. 8 illustrates a method of displaying 3D user recognition information when 2D reproduction and 3D reproduction can be selectively performed, according to an exemplary embodiment;

FIGS. 9A and 9B illustrate a screen on which a plurality of 3D user recognition information is simultaneously displayed, respectively;

FIG. 10 illustrates a format of a TS packet;

FIG. 11 illustrates a format of a PES packet;

FIG. 12 illustrates a format of an ES stream;

FIG. 13 is a block diagram of an external reproduction device included in one of the datastream reproducing apparatuses, according to an exemplary embodiment;

FIG. 14 is a block diagram of an external reproduction device included in another one of the datastream reproducing apparatuses, according to another exemplary embodiment;

FIG. 15 is a block diagram of a display device included in the datastream reproducing apparatuses, according to an exemplary embodiment;

FIG. 16 is a block diagram of a display device included in the datastream reproducing apparatuses, according to another exemplary embodiment;

FIG. 17 is a block diagram of a display device included in the datastream reproducing apparatuses, according to another exemplary embodiment;

FIG. 18 is a schematic diagram of information communication between a source device and a sink device based on an HDMI interface;

FIG. 19 is a first operation example of the external reproduction device and the display device according to an embodiment of the datastream reproducing apparatus;

FIG. 20 is a second operation example of the external reproduction device and the display device according to an embodiment of the datastream reproducing apparatus;

FIG. 21 is a third operation example of the external reproduction device and the display device according to an embodiment of the datastream reproducing apparatus;

FIG. 22 is a fourth operation example of the external reproduction device and the display device according to an embodiment of the datastream reproducing apparatus;

FIG. 23 is a fifth operation example of the external reproduction device and the display device according to an embodiment of the datastream reproducing apparatus;

FIG. 24 is a flowchart of an operation for displaying 3D user recognition information in a datastream reproducing apparatus;

FIG. 25 is a flowchart of a datastream generating method for displaying 3D user recognition information according to an exemplary embodiment; and

FIG. 26 is a flowchart of a datastream reproducing method for displaying 3D user recognition information according to an exemplary embodiment.

### DETAILED DESCRIPTION OF THE EXEMPLARY EMBODIMENTS

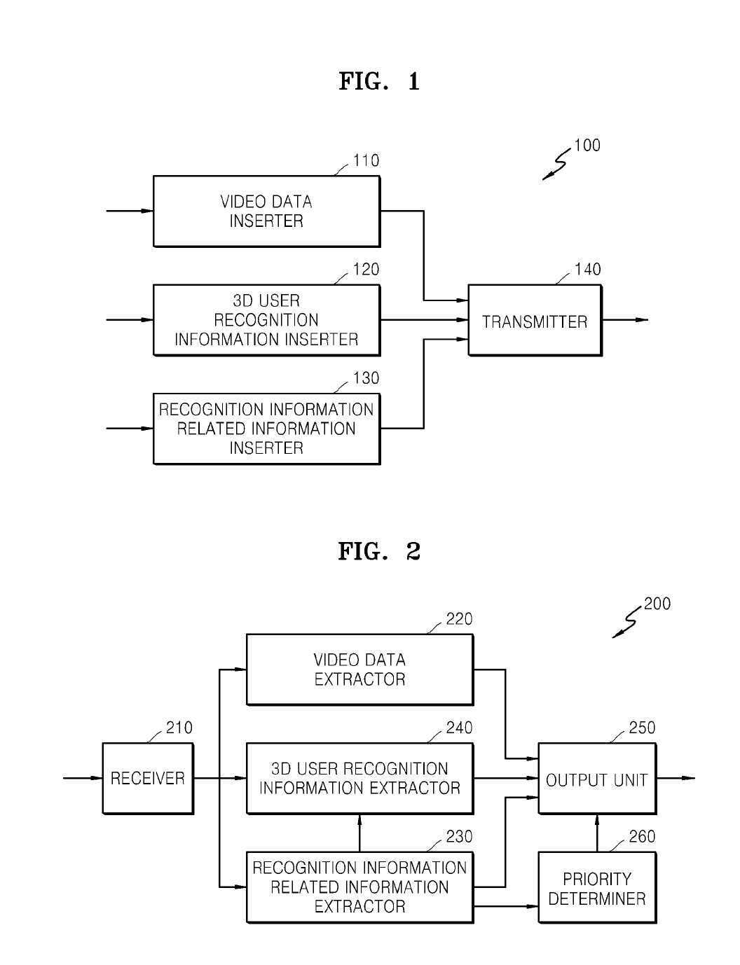

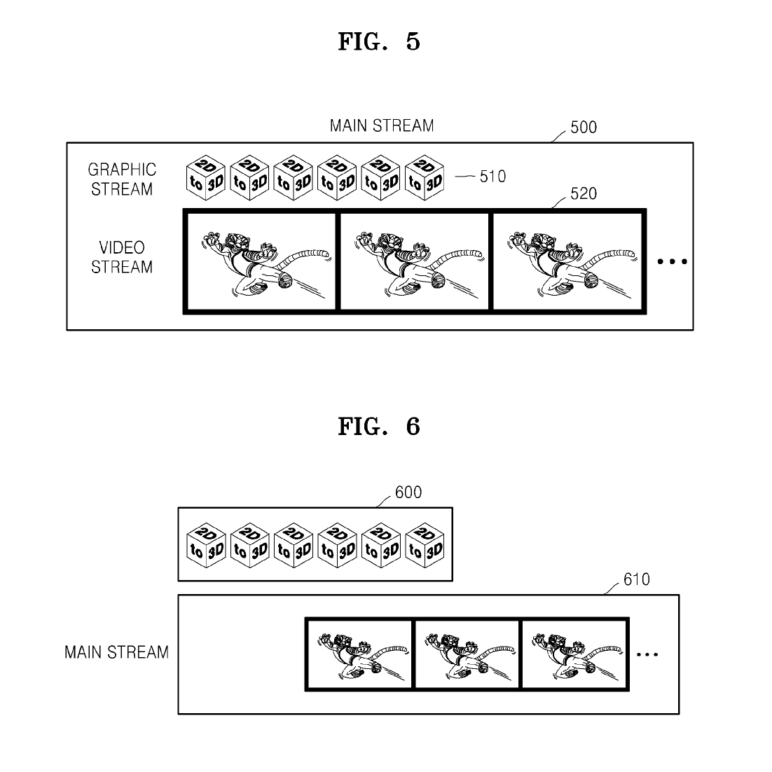

Hereinafter, various exemplary embodiments of a datastream generating apparatus for displaying 3D user recognition information, a datastream reproducing apparatus for displaying 3D user recognition information, and a datastream generating method and a datastream reproducing method corresponding to them, respectively, will be described with reference to FIGS. 1 to 26.

FIG. 1 is a block diagram of a datastream generating apparatus 100 for displaying 3D user recognition information according to an exemplary embodiment.

Referring to FIG. 1, the datastream generating apparatus 100 includes a video data inserter 110, a three-dimensional (3D) user recognition information inserter 120, a recognition information related information inserter 130, and a transmitter 140.

The video data inserter 110 may insert encoded video data of 2D video content or 3D video content into a datastream. Alternatively, both the video data of the 2D video content and the video data of the 3D video content may be inserted into the datastream. For example, if the datastream generating apparatus 100 supports a Moving Picture Experts Group-Transport Stream (MPEG-TS) scheme, the video data may be stored in a payload field, which is a data field of an Elementary Stream (ES) stream.

A 3D video format of the video data of the 3D video content may be one of a side-by-side format, a top-and-bottom format, a vertical line interleaved format, a horizontal line interleaved format, a field sequential format, and a frame sequential format.

The 3D user recognition information inserter 120 may insert into the datastream 3D user recognition information including a mark used for a user to recognize that a 3D video is being reproduced.

The 3D user recognition information may be visual data, such as graphics and text, auditory data, such as audio, and various kinds of control data. The 3D user recognition information inserted into the datastream by the 3D user recognition information inserter 120 may be inserted by a content provider.

The 3D user recognition information inserter 120 may insert in the datastream 3D video user recognition information into an auxiliary ES stream instead of a main ES stream into which the video data is inserted. In this case, the main ES stream and the auxiliary ES stream may be multiplexed into one stream. Alternatively, the 3D user recognition information inserter 120 may insert in the datastream the 3D video user recognition information into an ES stream separate from an ES stream into which the video data is inserted. Alternatively, the 3D user recognition information inserter 120 may insert in the datastream the 3D video user recognition information as additional data of an ES stream into which the video data is inserted.

The 3D user recognition information can be classified into fixed 3D user recognition information provided by a content provider and 3D user recognition information unique to a display apparatus, such as an external reproduction device or a display device. When 3D user recognition information is not provided by a content provider or a user's input, 3D user recognition information stored in a storage of a display apparatus may be used.

Accordingly, the datastream generating apparatus 100 may insert into the datastream additional information indicating whether the 3D user recognition information is included in a video datastream by a content provider. That is, the additional information can be defined according to whether the datastream generating apparatus 100 has inserted the 3D user recognition information into the video datastream.

Hereinafter, the additional information is referred to as recognition information related information. The recognition information related information according to an exemplary embodiment may include recognition information insertion information indicating whether 3D user recognition information is inserted in a datastream and display rights information indicating whether displaying of unique 3D user recognition information is authorized to a display apparatus. For example, if the recognition information insertion information indicates that 3D user recognition information is inserted in a current datastream, the display rights information may be set to indicate that displaying of unique 3D user recognition information is not authorized to a reproduction device.

The recognition information related information inserter 130 may insert the recognition information insertion information and the display rights information into the datastream. The recognition information related information inserter 130 may insert the recognition information insertion information and the display rights information into one of a Transport Stream (TS) packet, a Packetized Elementary Stream (PES) packet, and an Elementary Stream (ES) of the datastream.

According to an embodiment, the recognition information related information inserter 130 may determine the recognition information insertion information and the display rights information to be output in a TS packet level of the datastream. In the recognition information related information inserter 130, a video descriptor including the recognition information insertion information and the display rights information may be inserted into a data field of a predetermined TS packet among TS packets of the datastream. For example, the recognition information related information inserter 130 may allocate Packet IDentifier (PID) information of a header field of a TS packet as one of reserved values.

According to another embodiment, the recognition information related information inserter 130 may also determine the recognition information insertion information and the display rights information to be output in a TS packet level of the datastream. In this embodiment of the recognition information related information inserter 130, a PID value of a header field of a TS packet may be set so that the PID value of a header field of a TS packet indicates the recognition information insertion information and the display rights information.

For example, it is assumed that values which can be allocated as PID information of a header field of a TS packet correspond to 2D/3D video characteristics of video data inserted into the datastream, and the recognition information insertion information and the display rights information on a one-to-one basis. In this embodiment of the recognition information related information inserter 130, reserved values corresponding to combinations of current 2D/3D video characteristics, and the recognition information insertion information and the display rights information may be allocated to PID information of TS packets.

In another embodiment, the recognition information related information inserter 130 may determine the recognition information insertion information and the display rights information to be output in a PES packet level of the datastream. In this embodiment of the recognition information related information inserter 130, the recognition information insertion information and the display rights information may be inserted into a PES private data field, which is a lower field of an optional header field of a predetermined PES packet among PES packets of the datastream.

In yet another embodiment, the recognition information related information inserter 130 may determine the recognition information insertion information and the display rights information to be output in an ES packet level of the datastream. In this embodiment of the recognition information related information inserter 130, the recognition information insertion information and the display rights information may be inserted into a user data field, which is a lower field of an extension and user field of an ES stream of the datastream.

The transmitter 140 may receive the datastream into which various kinds of data is inserted by the video data inserter 110, the 3D user recognition information inserter 120, and the recognition information related information inserter 130, and transmit the datastream through one channel.

FIG. 2 is a block diagram of a datastream reproducing apparatus 200 for displaying 3D user recognition information according to an exemplary embodiment.

Referring to FIG. 2, the datastream reproducing apparatus 200 may include a receiver 210, a video data extractor 220, a recognition information related information extractor 230, a 3D user recognition information extractor 240, an output unit 250, and a priority determiner 260.

The receiver 210 may receive and parse a datastream including video data of 2D video content or 3D video content.

The video data extractor 220 may extract the video data from the datastream parsed by the receiver 210. The recognition information related information extractor 230 extracts recognition information related information from the datastream parsed by the receiver 210. The recognition information related information may include recognition information insertion information and display rights information.

The recognition information related information extractor 230 may extract from the datastream the recognition information insertion information and the display rights information transmitted in a level of one of a TS packet, a PES packet, and an ES stream of the datastream. In the exemplary embodiments of the recognition information related information extractor 230, which are classified according to positions from which the recognition information related information is extracted, the recognition information insertion information and the display rights information may be extracted and read from one of a TS packet, a PES packet, and an ES stream of the datastream.

In an exemplary embodiment of the recognition information related information extractor 230, a video descriptor including the recognition information insertion information and the display rights information may be extracted from a data field of a TS packet including PID information allocated as one of reserved values from among TS packets of the datastream.

In another exemplary embodiment of the recognition information related information extractor 230, the recognition information insertion information and the display rights information may be read from reserved values, which can be allocated to PID information of a header field of a TS packet. If it is defined that combinations of 2D/3D video characteristics of the video data inserted into the datastream, and the recognition information insertion information and the display rights information correspond to reserved values of PID information of the TS packets on a one-to-one basis, the recognition information related information extractor 230 may read current 2D/3D video characteristics, the recognition information insertion information and the display rights information based on values of the PID information of the TS packets of the datastream.

In another exemplary embodiment of the recognition information related information extractor 230, the recognition information insertion information and the display rights information may be extracted from a PES private data field, which is a lower field of an optional header field of a predetermined PES packet among the PES packets of the datastream.

In yet another exemplary embodiment of the recognition information related information extractor 230, the recognition information insertion information and the display rights information may be extracted from a user data field, which is a lower field of an extension and user field of an ES stream of the datastream.

The output unit 250 may control one of an external reproduction device and a display device to display 3D user recognition information on the video content based on the recognition information insertion information and the display rights information extracted by the recognition information related information extractor 230. The 3D user recognition information may be extracted from one of the datastream provided by a content provider, a storage of the external reproduction device, and a storage of the display device.

If the recognition information related information extractor 230 confirms based on the recognition information insertion information that the 3D user recognition information provided by a provider of the video content is not inserted in the datastream and confirms based on the display rights information that displaying of 3D user recognition information on the video content unique to the external reproduction device and the display device is authorized, the priority determiner 260 may determine a display apparatus having priority of rights for displaying the unique 3D user recognition information on the video content from among the external reproduction device and the display device. Hereinafter, for convenience of description, a display apparatus to which priority of rights for displaying unique 3D user recognition information on video content is granted by the priority determiner 260 is called ‘recognition information priority display device’, and a display apparatus to which the priority is not granted is referred to as ‘recognition information non-priority display device’.

In this case, the output unit 250 may output, via the recognition information priority display device, a video stream on which the 3D user recognition information is displayed, based on the priority of display rights between the external reproduction device and the display device, which is determined by the priority determiner 260.

The 3D user recognition information extractor 240 may extract the 3D user recognition information from the datastream parsed by the receiver 210, based on the recognition information insertion information extracted by the recognition information related information extractor 230. The 3D user recognition information provided by the content provider may be synthesized with the video content or extracted from data separate from the video content.

If the recognition information related information extractor 230 confirms based on the recognition information insertion information that the 3D user recognition information provided by the provider of the video content is inserted into the datastream, the video data extractor 220 may extract the video data on which the extracted 3D user recognition information is displayed from the datastream, and the output unit 250 may output the extracted video data.

Alternatively, if the recognition information related information extractor 230 confirms based on the recognition information insertion information that the 3D user recognition information provided by the provider of the video content is inserted into the datastream, the recognition information related information extractor 230 may extract the 3D user recognition information from the datastream, and the output unit 250 may blend the 3D user recognition information extracted from the datastream by the recognition information related information extractor 230 and the video data extracted from the datastream by the video data extractor 220 and output the blended data.

If a main ES stream into which the video data is inserted and an auxiliary ES stream are demultiplexed from one stream, the 3D user recognition information extractor 240 may extract the 3D user recognition information from the auxiliary ES stream.

Alternatively, the 3D user recognition information extractor 240 may extract the 3D user recognition information from an ES stream separate from an ES stream into which the video data is inserted in the datastream.

Alternatively, the 3D user recognition information extractor 240 may extract the 3D user recognition information as additional data of an ES stream into which the video data is inserted in the datastream.

A description of a subsequent operation of the datastream reproducing apparatus 200 to display 3D user recognition information on the video content when the recognition information related information extractor 230 confirms based on the recognition information insertion information that the 3D user recognition information provided by the provider of the video content is not inserted into the datastream is as follows.

If the recognition information related information extractor 230 confirms based on the display rights information that displaying of 3D user recognition information unique to the external reproduction device on the video content is authorized to the external reproduction device, the output unit 250 may control the external reproduction device to blend the 3D user recognition information unique to the external reproduction device and the video data and output a video stream on which the unique 3D user recognition information is displayed.

Alternatively, if the recognition information related information extractor 230 confirms based on the display rights information that displaying of 3D user recognition information unique to the display device on the video content is authorized to the display device, the output unit 250 may control the display device to blend the 3D user recognition information unique to the display device, which is stored in the storage of the display device, and the video data and output a video stream on which the unique 3D user recognition information is displayed.

A description of exemplary embodiments in which the priority determiner 260 determines priority of rights of displaying the unique 3D user recognition information between the external reproduction device and the display device on the video content if the recognition information related information extractor 230 confirms based on the recognition information insertion information that the 3D user recognition information provided by the provider of the video content is not inserted into the datastream and confirms based on the display rights information that displaying of the unique 3D user recognition information on the video content is authorized to both the external reproduction device and the display device is as follows.

The priority determiner 260 may determine display capabilities of the external reproduction device and the display device to display each unique 3D user recognition information of the external reproduction device and the display device. The priority determiner 260 may confirm display capability of each unique 3D user recognition information of the external reproduction device and the display device, and the output unit 250 may control a device having the display capability to blend the corresponding unique 3D user recognition information and the video data and output a video stream on which the unique 3D user recognition information is displayed. If both the external reproduction device and the display device have the display capability, the priority determiner 260 may determine priority of displaying the corresponding unique 3D user recognition information on one of the external reproduction device and the display device.

Alternatively, the priority determiner 260 may determine the priority between the external reproduction device and the display device based on a user's input or an initial setup. The priority determiner 260 may control a recognition information priority display device to modify or update display rights information of a recognition information non-priority display device so that the recognition information non-priority display device does not display its unique 3D user recognition information.

Alternatively, the priority determiner 260 may restrict 3D user recognition information processing capability of a recognition information non-priority display device by allowing a recognition information priority display device to separately set 3D user recognition information processing prohibition information and transmit the 3D user recognition information processing prohibition information to the recognition information non-priority display device.

Hereinafter, display rights information or 3D user recognition information processing prohibition information set or updated by another display apparatus to determine priority of 3D display rights is called priority determining information.

Priority determining information according to an exemplary embodiment may be exchanged through an interface supporting data communication between the external reproduction device and the display device. If data between the external reproduction device and the display device is exchanged through a High-Definition Multimedia Interface (HDMI) interface, the priority determining information may be transmitted through one channel of a Transition Minimized Differential Signaling (TDMS) channel and a Consumer Electronics Control (CEC) line.

When a video data period is transmitted immediately next to a control period of the TDMS channel, the priority determining information according to an exemplary embodiment may be allocated to the last bit of preamble data transmitted in the control period, the preamble data being transmitted to the other device through the TDMS channel.

When priority determining information is transmitted using control data of the CES line, an opcode (operation code) for indicating information for setting the priority determining information according to an exemplary embodiment may be defined, and an address of the other device receiving the priority determining information and the control data may be inserted as an operand of the opcode.

Based on the priority determining information, the output unit 250 may restrict a blending function of unique 3D user recognition information and the video data for a device which has received the priority determining information, and control a device having the priority to blend unique 3D user recognition information and the video data and output a video stream on which the unique 3D user recognition information is displayed.

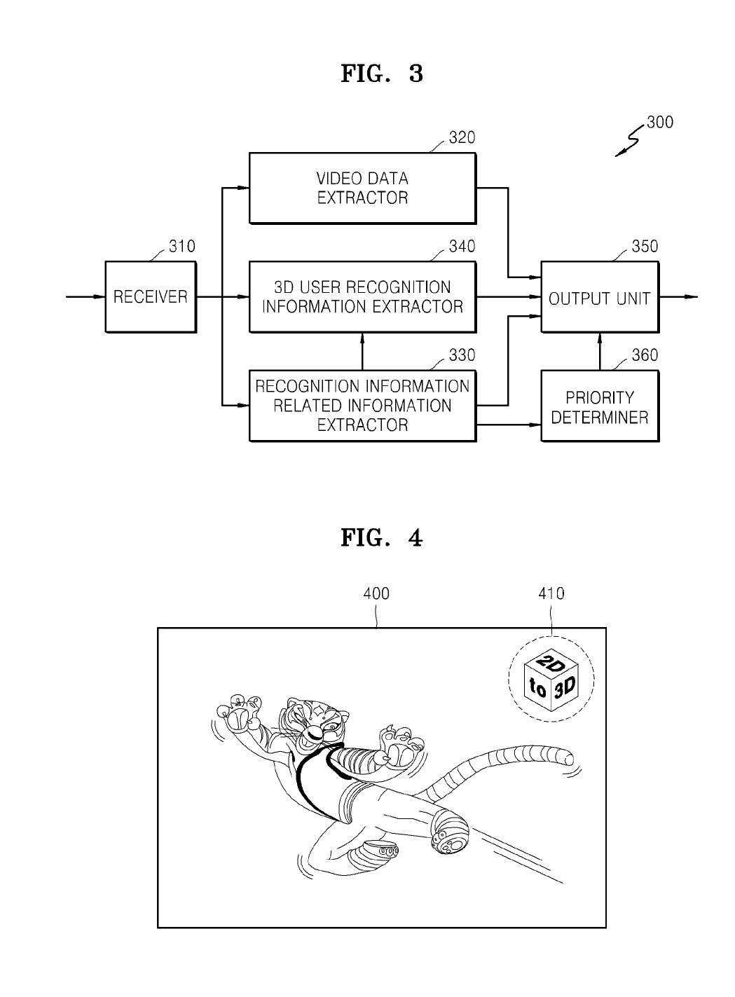

FIG. 3 is a block diagram of another embodiment of a datastream reproducing apparatus 300 for displaying 3D user recognition information.

Referring to FIG. 3, the datastream reproducing apparatus 300 includes a receiver 310, a video data extractor 320, a recognition information related information extractor 330, a 3D user recognition information extractor 340, and an output unit 350. The datastream reproducing apparatus 300 is different from the datastream reproducing apparatus 200 in that an external reproduction device is not taken into account.

Thus, the receiver 310, the video data extractor 320, the recognition information related information extractor 330, the 3D user recognition information extractor 340, and the output unit 350 basically correspond to the receiver 210, the video data extractor 220, the recognition information related information extractor 230, the 3D user recognition information extractor 240, and the output unit 250, respectively, except that display rights information of the external reproduction device and priority of display rights are not taken into account.

That is, if the recognition information related information extractor 330 confirms based on recognition information insertion information that 3D user recognition information provided by a provider of video content is not inserted into a datastream and confirms based on display rights information that displaying of 3D user recognition information unique to a display device on video content is authorized to the display device, the output unit 350 may control the display device to extract the unique 3D user recognition information from a storage of the display device, blend the unique 3D user recognition information and video data, and output the video data with which the unique 3D user recognition information is synthesized.

Even though it is confirmed based on the display rights information that displaying of 3D user recognition information unique to the external reproduction device on the video content is authorized to the external reproduction device, the output unit 350 may control the display device to output the unique 3D user recognition information from the storage of the display device.

FIGS. 4 to 6 illustrate 3D user recognition information provided together with video content by a content provider, according to exemplary embodiments.

The content provider may provide 3D user recognition information together with video content. For example, in a 3D video display apparatus using a 3D glasses scheme, 3D user recognition information may include recognition information for informing whether a user needs to wear 3D glasses to enjoy current video content. For another example, in a 3D video display apparatus using a non-glasses scheme, 3D user recognition information may include recognition information for informing whether a user needs to enjoy video in a sweet spot for the enjoy of current video content.

The content provider may produce 2D video content or 3D video content so that 3D user recognition information is included in 2D video data or 3D video data. For example, the content provider may produce video content so that video content data of which 3D user recognition information 410 is synthesized with video data 400 is displayed during a predetermined period of time.

Alternatively, the content provider may produce a datastream for video content in an In-MUX format. In this case, a video stream 520 of video data and a graphic stream 510 of 3D user recognition information can be multiplexed as separate streams in a main stream 500 for video content transmission.

Alternatively, the content provider may produce a datastream for video content in an Out-of-MUX format. In this case, a main stream 610 for video content transmission may include video data, and an auxiliary stream 600 may include graphic data of 3D user recognition information.

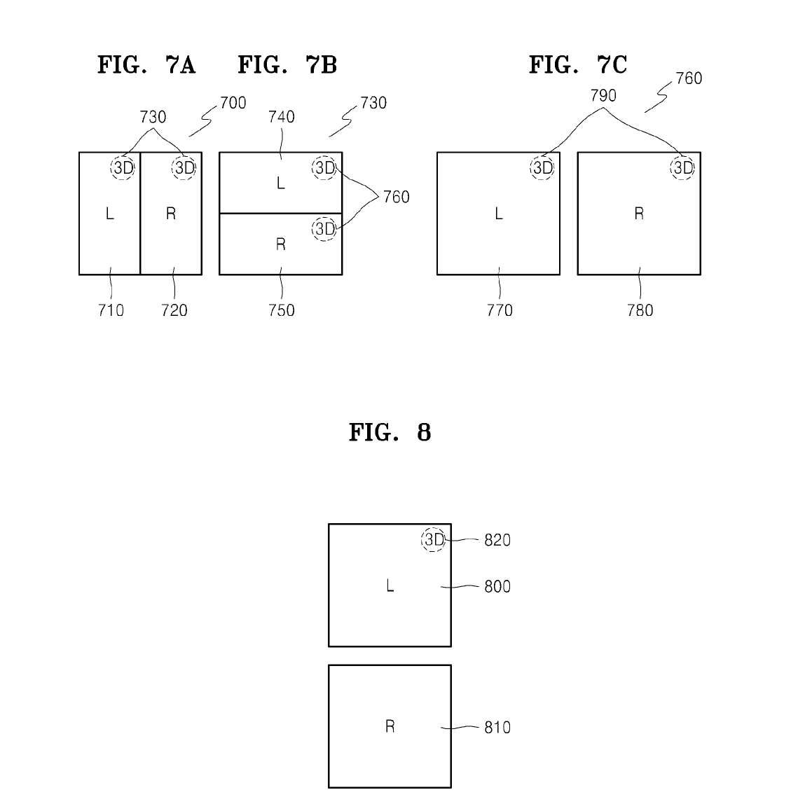

FIGS. 7A, 7B and 7C illustrate 3D user recognition information displayed on video content by a content provider according to 3D video formats for only 3D reproduction, respectively, according to exemplary embodiments.

The content provider may provide 3D video content of a 3D video format by considering 3D display devices for only 3D reproduction. The 3D video format may include a side-by-side format 700, a top-and-bottom format 730, and a field/frame sequential format 760, etc.

A left visual point image component and a right visual point image component are arranged side by side in a left area 710 and a right area 720 of a 3D image picture of the side-by-side format 700, respectively. A left visual point image component and a right visual point image component are arranged in a line in a top area 740 and a bottom area 750 of a 3D image picture of the top-and-bottom format 730, respectively. A left visual point image component and a right visual point image component are sequentially arranged in an odd field/frame 770 and an even field/frame 780 of a 3D image picture of the field/frame sequential format 760, respectively.

The content provider may produce and distribute 3D video content so that 3D user recognition information is displayed on 3D video content of a 3D video format for only 3D reproduction. That is, the content provider may produce 3D video content so that 3D user recognition information 730 is displayed in the picture left area 710 and the picture right area 720 of the side-by-side format 700, 3D user recognition information 760 is displayed in the picture top area 740 and the picture bottom area 750 of the top-and-bottom format 730, or 3D user recognition information 790 is displayed in the odd field/frame 770 and the even field/frame 780 of the 3D image picture of the field/frame sequential format 760.

FIG. 8 illustrates a method of displaying 3D user recognition information when compatibility with a 2D display apparatus is taken into account.

A content provider may provide a video content service in which a left visual point image 800 and a right visual point image 810 are separately transmitted by considering 2D display apparatuses capable of only 2D reproduction. In this case, since the content provider cannot display 3D user recognition information 820 on video content, if a 3D display apparatus uses this video content service, the 3D display apparatus cannot display the 3D user recognition information 820 together with the video content even if the 3D display apparatus can perform 3D reproduction of 3D video content by using both the left visual point image 800 and the right visual point image 810.

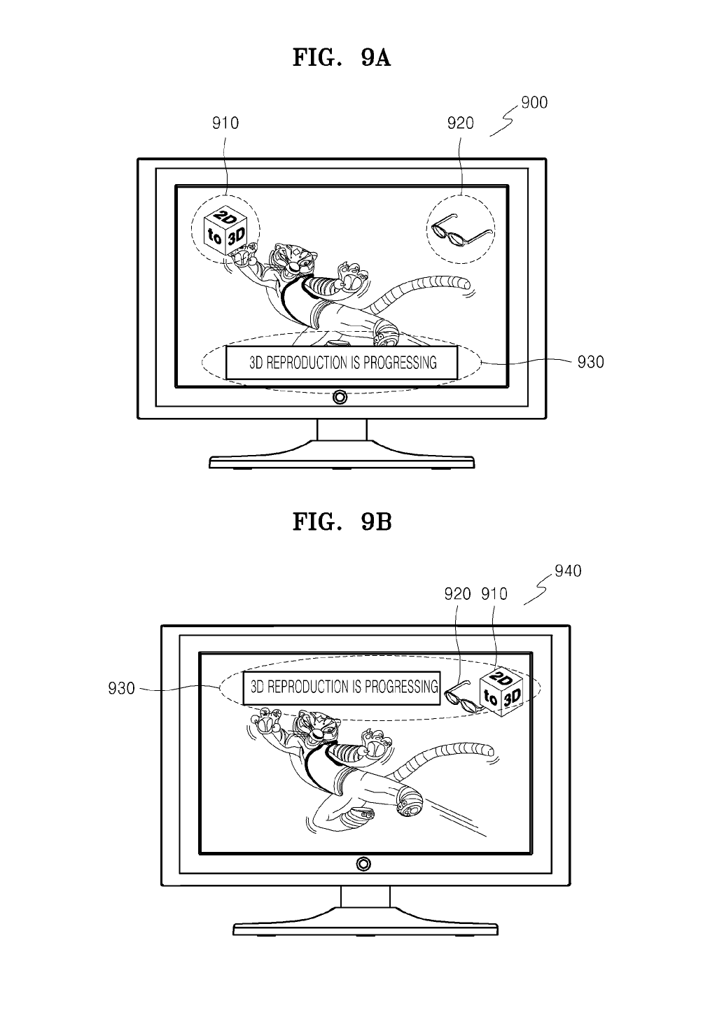

FIGS. 9A and 9B illustrate a screen on which a plurality of 3D user recognition information is simultaneously displayed, respectively.

3D user recognition information of a display apparatus may be displayed on video content when 3D video data is reproduced by using 3D user recognition information included in the display apparatus besides 3D user recognition information provided by a content provider.

Examples of display apparatuses are an external reproduction device and a display device. The external reproduction device includes a set-top box, a Digital Versatile Disc (DVD) player, a Blu-ray Disc (BD) player, etc., and the display device includes a television (TV), a monitor, etc.

That is, since 3D user recognition information 910 provided by the content provider, 3D user recognition information 920 displayed by the external reproduction device, and 3D user recognition information 930 displayed by the display device can be displayed on video content, the 3D user recognition information 910, 920, and 930 may be displayed all together, or depth perception between the 3D user recognition information 910, 920, and 930 and objects on the video content may be displayed in a reversal way.

For example, two or more pieces of the 3D user recognition information 910, 920, and 930 may be finally displayed on an output screen 900 of the display device or overlapped on an output screen 940.

Basically, if video content including 3D user recognition information is provided by the content provider, it is preferable, but not necessary that only the 3D user recognition information provided by the content provider be displayed. However, if provided video content does not include 3D user recognition information, 3D user recognition information of the external reproduction device and the display device should be used, and it is preferable, but not necessary that only one of the external reproduction device and the display device display 3D user recognition information on video content.

The datastream generating apparatus 100 according to an exemplary embodiment may set recognition information insertion information and display rights information so that 3D user recognition information can be reproduced in a right way and transmit the recognition information insertion information and the display rights information together with video content. The recognition information related information inserter 130 may insert a video descriptor including recognition information insertion information and display rights information in a payload field 1020 of a TS packet 1000. Table 1 shows a syntax of a video descriptor ‘Video_descriptor’ including recognition information related information according to an exemplary embodiment.

TABLE 1
Syntax

```
Video_descriptor{
  Mode
  Format
  Mode_change_info_flag
  Mode_change_permission
  Reserved
}
```

Table 2 shows a semantic of reproduction mode information ‘Mode’ of the video descriptor of Table 1.

TABLE 2
Mode

| Semantic | Value |
|---|---|
| 2D video | 0 |
| 3D video | 1 |

2D/3D video mode information ‘Mode’ can indicate whether 2D video content or 3D video content is inserted into a current datastream.

Table 3 shows a semantic of 3D video format information ‘Format’ of the video descriptor of Table 1.

TABLE 3
Format

| Semantic | Value |
|---|---|
| Full picture | 00 |
| Side by side | 01 |
| Top & bottom | 10 |
| Checker board | 11 |
| . . . | . . . |

The video format information ‘Format’ can indicate a 3D video format of 3D video content when 3D video content is inserted into a current datastream. A full picture format is a 3D video format in the case where a picture of a left visual point image and a picture of a right visual point image of 3D video are provided with full resolution. In a checker board format, blocks of a left visual point image component and blocks of a right visual point image component forms a chessboard shape by being alternately placed on a picture divided into predetermined-sized blocks. However, when the reproduction mode information ‘Mode’ indicates a 2D reproduction mode, 3D video format information ‘Format’ may not be used.

Table 4 shows a semantic of recognition information insertion information ‘Mode_change_info_flag’ of the video descriptor of Table 1.

TABLE 4
Mode_change_info_flag

| Semantic | Value |
|---|---|
| 3D user recognition information is | 0 |
| not included in a video datastream | |
| 3D user recognition information | 1 |
| is included in a video datastream | |

3D user recognition information is included in a video datastream 1

The recognition information insertion information ‘Mode_change_info_flag’ indicates whether user recognition information provided by a content provider is included in a current video datastream.

Table 5 shows a semantic of display rights information ‘Mode_change_permission’ of the video descriptor of Table 1.

TABLE 5
Mode_change_permission

| Semantic | Value |
|---|---|
| Displaying of 3D user recognition | 0 |
| information is not authorized | |
| Displaying of 3D user recognition | 1 |
| information is authorized | |

The display rights information ‘Mode_change_permission’ indicates whether Displaying of 3D user recognition information is authorized to a current display apparatus. Even though the current display apparatus has its unique 3D user recognition information, if a value of the display rights information ‘Mode_change_permission’ for the current display apparatus is set to ‘0’, the current display apparatus does not output its unique 3D user recognition information, and only if the display rights information ‘Mode_change_permission’ for the current display apparatus is set to ‘1’, the current display apparatus can output its unique 3D user recognition information.

However, if a value of the recognition information insertion information ‘Mode_change_info_flag’ is set to ‘1’, since 3D user recognition information provided by a content provider is included in a current video datastream, it is preferable, but not necessary that the value of the display rights information ‘Mode_change_permission’ for the current display apparatus be set to ‘0’.

Another embodiment of the recognition information related information inserter 130 may set a PID value of a header field of a TS packet so that the PID value of a header field of a TS packet indicates recognition information insertion information and display rights information. For example, the recognition information related information inserter 130 may allocate reserved values corresponding to combinations of current 2D/3D video characteristics, and the recognition information insertion information and the display rights information to PID information of TS packets. Table 6 shows an example in which PID values are set to correspond to recognition information related information.

TABLE 6
PID

| Value | Semantic |
|---|---|
| 0x0003 | 2D video content |
| 0x0004 | 3D video content & 3D user recognition |
| | information included in datastream |
| 0x0005 | 3D video content & 3D user recognition |
| | information not included in datastream |
| 0x0006 | 3D video content & 3D user recognition |
| | information not included in datastream & |
| | display rights information authorized |
| 0x0007 | 3D video content & 3D user recognition |
| | information included in datastream & |
| | display rights information not authorized |

Values of 0x0003 to 0x000F among PID values of a TS packet defined by the International Organization for Standardization (ISO) 13818-1 standard are reserved values. The recognition information related information inserter 130 may set the recognition information related information by allocating combinations of related information for displaying 3D user recognition information, such as whether 2D/3D video content is inserted into a current datastream, whether 3D user recognition information provided by a content provider is inserted, and whether displaying of 3D user recognition information unique to a display apparatus is authorized, to values of 0x0003 to 0x0007 among the reserved values of the PID values.

The recognition information related information inserter 130 may guarantee lower compatibility with the existing broadcasting, which does not support 3D video broadcasting, by setting the recognition information related information by using the reserved value among the PID values.

The datastream reproducing apparatus 200 or 300 may reproduce 3D user recognition information together with video content in a right way by using recognition information insertion information and display rights information.

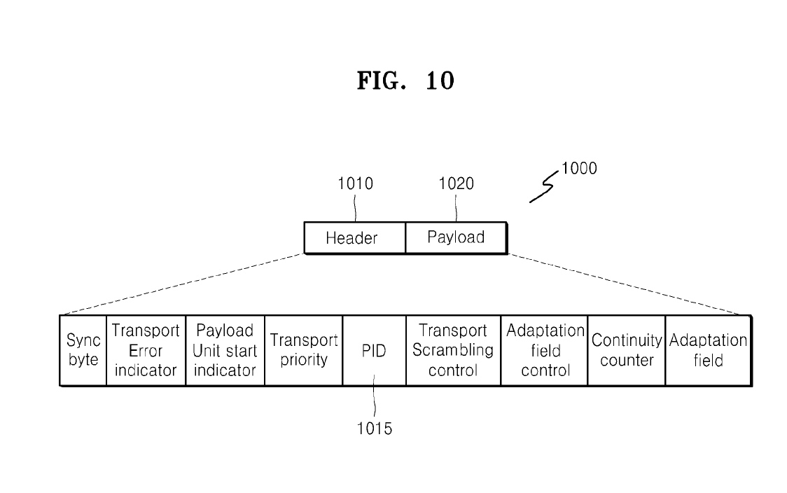

The recognition information related information inserter 130 of the datastream generating apparatus 100 may insert recognition information related information, such as recognition information insertion information and display rights information, into a level of one of a TS packet, a PES packet, and an ES stream of a datastream and transmit the datastream. The datastream reproducing apparatus 200 or 300 may extract the recognition information related information from a level of one of a TS packet, a PES packet, and an ES stream of a received datastream. A description will now be made of embodiments of a position into and from which recognition information related information is inserted and extracted with reference to FIGS. 10 to 12.

FIG. 10 illustrates a format of a TS packet 1000.

Referring to FIG. 10, the TS packet 1000 includes a header field 1010 and a payload field 1020. A PID value is allocated to a PID field 1015 of the header field 1010 of the TS packet 1000.

The datastream generating apparatus 100 may insert recognition information related information, such as recognition information insertion information and display rights information, into the TS packet 1000. The recognition information related information inserter 130 may generate the video descriptor including the recognition information related information, which has been described with reference to Tables 1 to 5, inserts the video descriptor into the payload field 1020, and allocate one of the reserved values of the PID values to the PID field 1015 of the header field 1010 of the TS packet 1000.

The other embodiment of the recognition information related information inserter 130 may set the value allocated to the PID field 1015 of the header field 1010 of the TS packet 1000 to correspond to the recognition information insertion information and the display rights information, as described above with reference Table 6.

An embodiment of the recognition information related information extractor 230 or 330 may extract the video descriptor including the recognition information insertion information and the display rights information from the payload field 1020 of the TS packet 1000 in which a PID reserved value is allocated to the PID field 1015.

Another embodiment of the recognition information related information extractor 230 or 330 may read the recognition information insertion information and the display rights information from the value of the PID field 1015 of the header field 1010 of the TS packet 1000. The recognition information related information extractor 230 or 330 may read the PID value itself of the TS packet 1000, and may read a combination of a 2D/3D video mode of current video content, and recognition information insertion information and display rights information inserted into a datastream, which correspond to the PID value, as described above with reference Table 6.

If 3D user recognition information provided by a content provider is included in the TS packet 1000 based on the recognition information insertion information extracted from the TS packet 1000, the 3D user recognition information may be extracted from the payload field 1020 of the TS packet 1000.

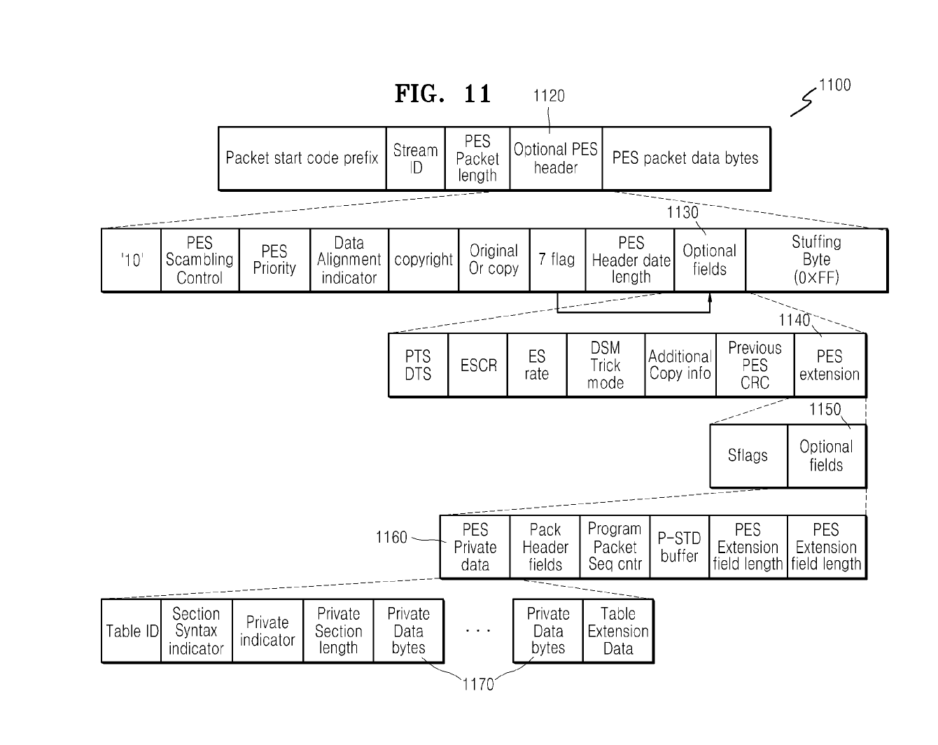

FIG. 11 illustrates a format of a PES packet 1100.

Referring to FIG. 11, the PES packet 1100 includes an optional PES header field 1120 and a PES packet data byte field. An optional fields field 1130 of the optional PES header field 1120 of the PES packet 1100 includes a PES extension field 1140. An optional fields field 1150 of the PES extension field 1140 includes a PES private data field 1160. The PES private data field 1160 includes one or more private data byte fields 1170.

Another embodiment of the recognition information related information inserter 130 may insert recognition information insertion information and display rights information into the PES private data field 1160, which is a lower field of the optional fields field 1150 of the PES packet 1100. For example, the recognition information related information inserter 130 may insert recognition information related information into the private data byte field 1170, which is a lower field of the PES private data field 1160.

The recognition information related information extractor 230 or 330 may extract the recognition information insertion information and the display rights information from the PES private data field 1160, which is a lower field of the optional fields field 1150 of the PES packet 1100. For example, the recognition information related information extractor 230 or 330 may extract the recognition information related information from the private data byte field 1170, which is a lower field of the PES private data field 1160.

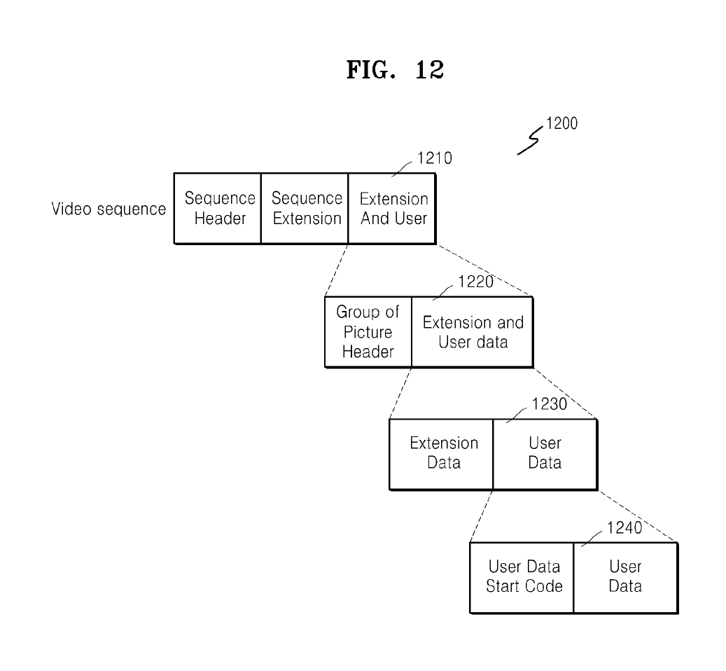

FIG. 12 illustrates a format of an ES stream 1200.

Referring to FIG. 12, the ES stream 1200 of a video sequence includes a sequence header field, a sequence extension field, and an extension and user field 1210. An extension and user data field 1220 of the extension and user field 1210 includes a user data field 1230, and the user data field 1230 also further includes a user data field 1240.

Another embodiment of the recognition information related information inserter 130 may insert recognition information insertion information and display rights information into the user data fields 1230 and 1240, which are lower fields of the extension and user field 1210 of the ES stream 1200.

The recognition information related information extractor 230 or 330 may extract the recognition information insertion information and the display rights information from the user data fields 1230 and 1240, which are lower fields of the extension and user field 1210 of the ES stream 1200.

The recognition information related information extractor 230 or 330 of the datastream reproducing apparatus 200 or 300 may extract recognition information insertion information from a datastream transmitted from the datastream generating apparatus 100 according to an exemplary embodiment and determine whether 3D user recognition information provided by a content provider is included in the datastream. If the 3D user recognition information is not included in the datastream, the datastream reproducing apparatus 200 or 300 may inform that a reproduction state of 2D video content and a reproduction state of 3D video content are planning to be changed or has been changed, by using 3D user recognition information unique to an external reproduction device or a display device.

The recognition information related information extractor 230 or 330 of the datastream reproducing apparatus 200 or 300 may extract display rights information from a datastream transmitted from the datastream generating apparatus 100 and determine whether displaying of 3D user recognition information unique to an external reproduction device or a display device on video content is authorized to the external reproduction device or the display device.

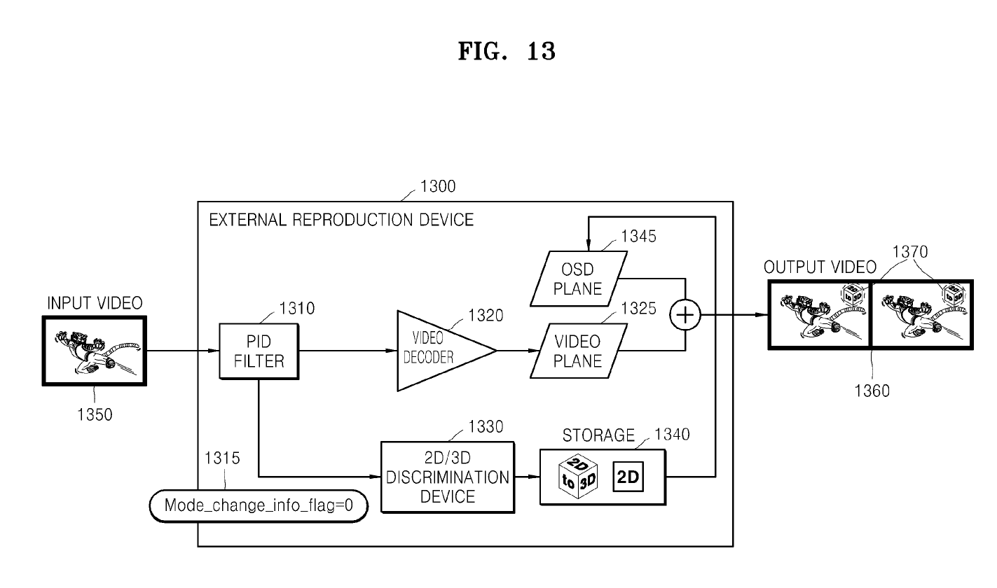

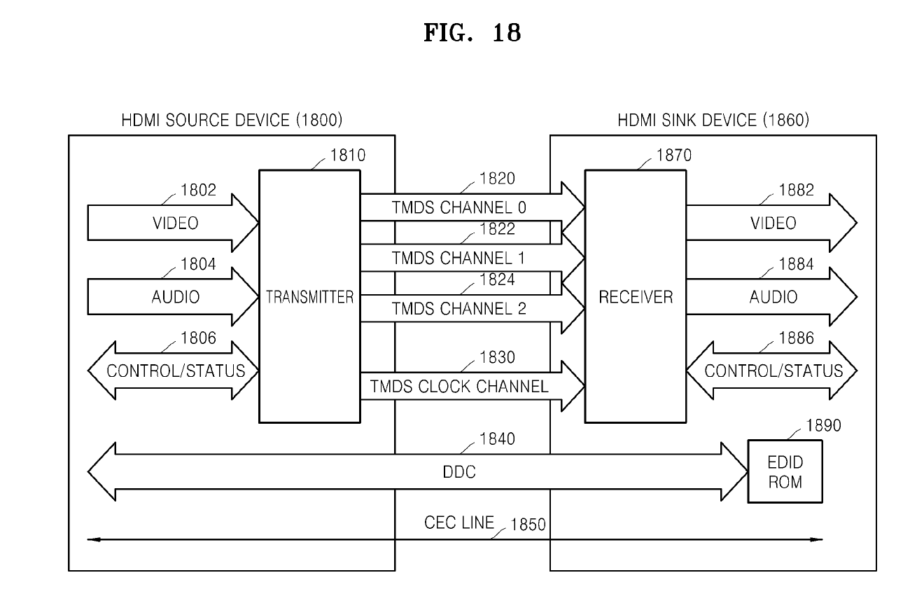

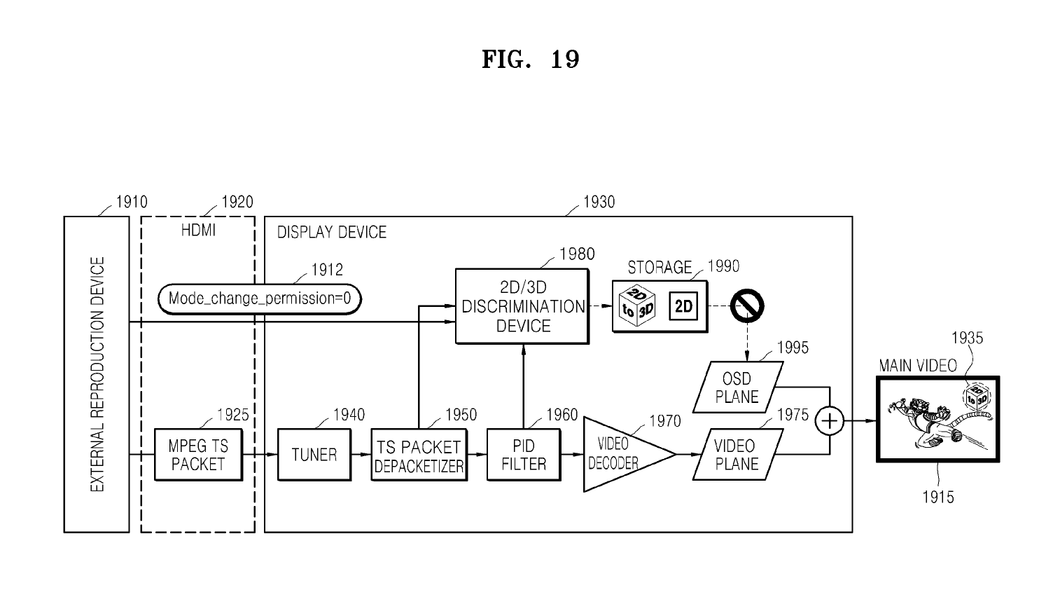

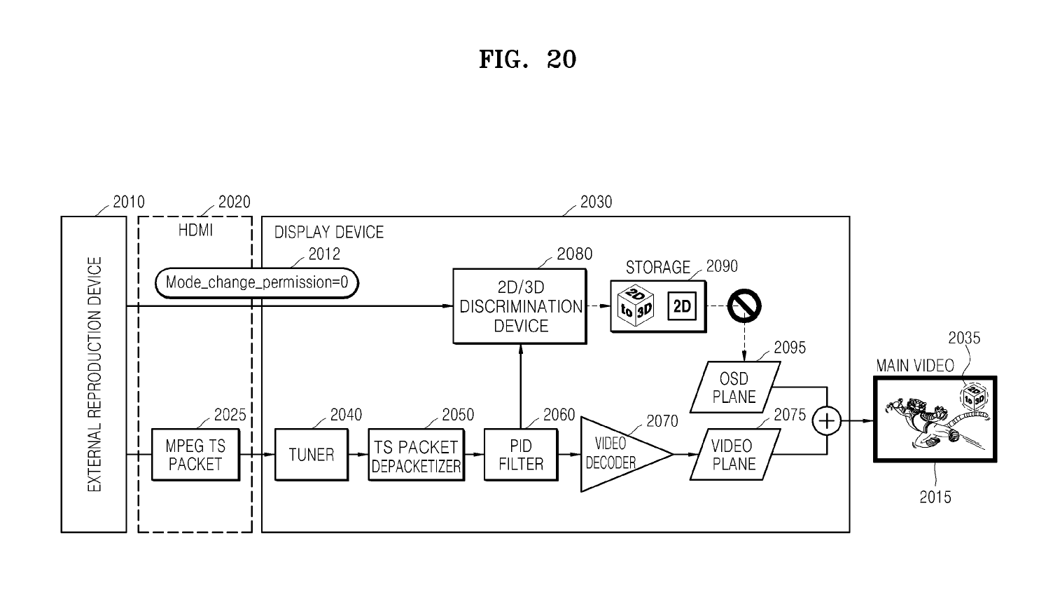

Embodiments in which an external reproduction device or a display device outputs its unique 3D user recognition information when display rights of the external reproduction device and the display device do not collide are described with reference to FIGS. 13 to 17. Further, embodiments in which an external reproduction device or a display device outputs its unique 3D user recognition information when display rights of the external reproduction device and the display device collide are described with reference to FIGS. 18 to 23.

FIG. 13 is a block diagram of an external reproduction device 1300 included in the datastream reproducing apparatus 200, according to an exemplary embodiment.

Referring to FIG. 13, the recognition information related information extractor 230 of the datastream reproducing apparatus 200 may read display rights information from a video datastream 1350 generated by the datastream generating apparatus 100 and confirm that displaying of 3D user recognition information is not authorized to a display device and displaying of 3D user recognition information unique to the external reproduction device 1300 on video content is authorized to the external reproduction device 1300.

The video datastream 1350 is input to the external reproduction device 1300. If recognition information related information is set at a TS packet level or a PES packet level, the recognition information related information extractor 230 may control a PID filter 1310 and a 2D/3D discrimination device 1330 of the external reproduction device 1300 to read recognition information insertion information and 2D/3D video mode information. The PID filter 1310 reads a PID value to extract recognition information related information including recognition information insertion information 1315. The recognition information related information extractor 230 can confirm that 3D user recognition information is not included in a current datastream, from a value of the recognition information insertion information 1315 set to ‘0’. Therefore, the recognition information related information extractor 230 may control the 2D/3D discrimination device 1330 to read 2D/3D video mode information from the recognition information related information extracted by the PID filter 1310.

Based on the read of the 2D/3D discrimination device 1330, the 3D user recognition information extractor 240 may extract the 3D user recognition information of the external reproduction device 1300 from a storage 1340.

The video data extractor 220 of the datastream reproducing apparatus 200 may extract video data from the video datastream 1350, and restore video content by decoding the video data. The output unit 250 of the datastream reproducing apparatus 200 may output video content 1360 and 3D user recognition information 1370 to be displayed together on a display screen by synthesizing a video plane 1325 of the restored video content and an On-Screen Display (OSD) plane 1345 of the 3D user recognition information of the external reproduction device 1300.

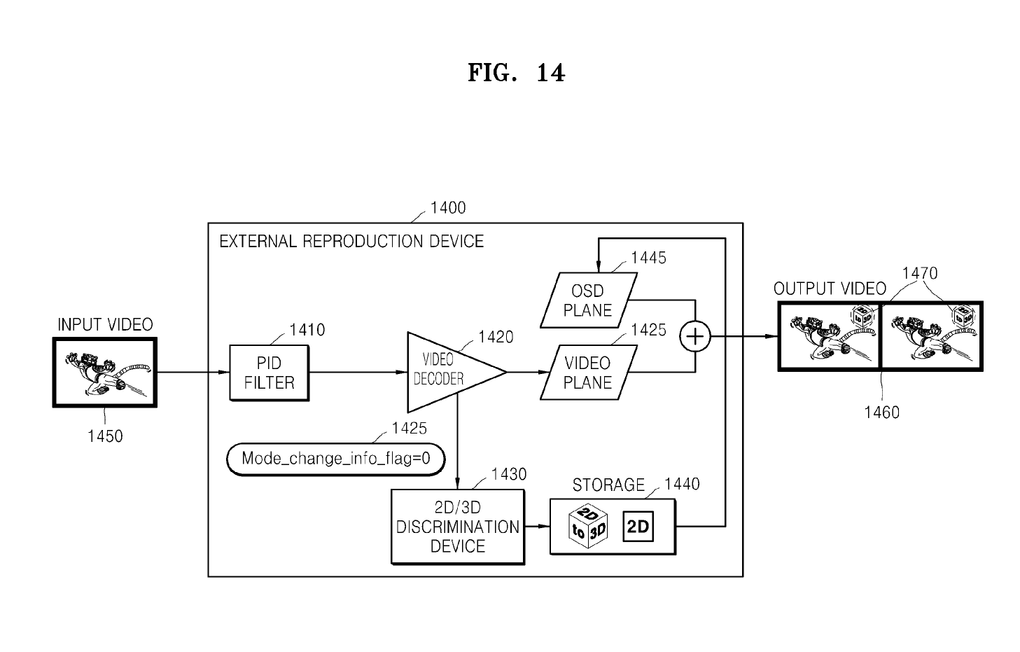

FIG. 14 is a block diagram of an external reproduction device 1400 included in the datastream reproducing apparatus 200, according to another exemplary embodiment.

Referring to FIG. 14, the recognition information related information extractor 230 of the datastream reproducing apparatus 200 may read display rights information from a video datastream 1450 generated by the datastream generating apparatus 100 and confirm that displaying of 3D user recognition information is not authorized to a display device and displaying of 3D user recognition information unique to the external reproduction device 1400 on video content is authorized to the external reproduction device 1400.

The video datastream 1450 is input to the external reproduction device 1400. If recognition information related information is set at an ES stream level, the recognition information related information extractor 230 may control a video decoder 1420 to extract recognition information insertion information 1425 from an ES stream and read the recognition information insertion information 1425 by passing through a PID filter 1410 of the external reproduction device 1400. The recognition information related information extractor 230 may confirm that 3D user recognition information is not included in a current datastream, from a value of the recognition information insertion information 1425 set to ‘0’. Therefore, the recognition information related information extractor 230 may control a 2D/3D discrimination device 1430 to read 2D/3D video mode information.

Based on reading of the 2D/3D discrimination device 1430, the 3D user recognition information extractor 240 may extract the 3D user recognition information of the external reproduction device 1400 from a storage 1440.

The output unit 250 of the datastream reproducing apparatus 200 may output video content 1460 and 3D user recognition information 1470 to be displayed together on a display screen by synthesizing a video plane 1425 of video content restored by the video decoder 1420 and an OSD plane 1445 of the 3D user recognition information of the external reproduction device 1400.

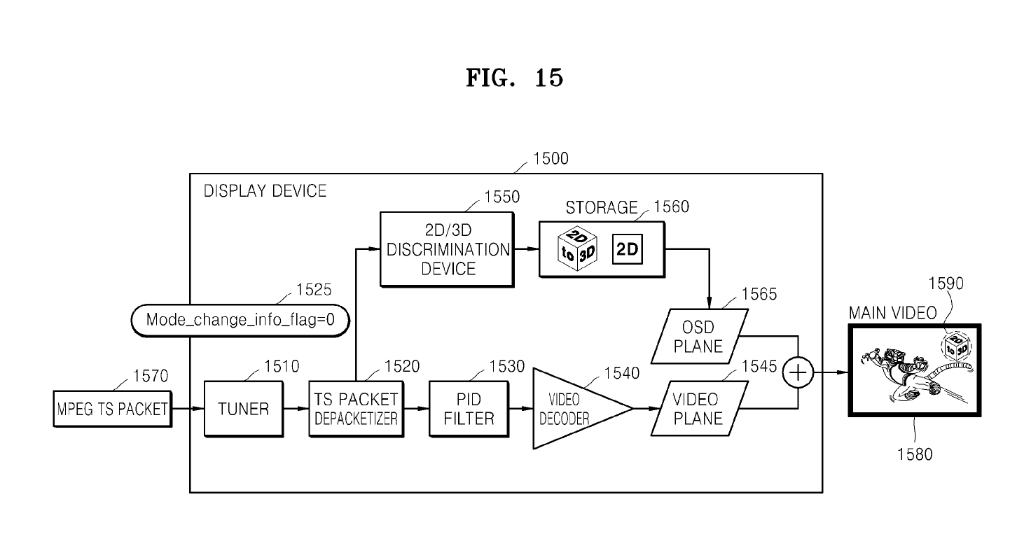

FIG. 15 is a block diagram of a display device 1500 included in the datastream reproducing apparatus 200 and the datastream reproducing apparatus 300, according to an exemplary embodiment.

Referring to FIG. 15, the recognition information related information extractor 230 or 330 may read display rights information from a video datastream generated by the datastream generating apparatus 100 and confirm that displaying of 3D user recognition information is not authorized to an external reproduction device and displaying of 3D user recognition information unique to the display device 1500 on video content is authorized to the display device 1500.

An MPEG TS packet 1570 of the video datastream is input to the display device 1500 and passed through a tuner 1510 to select a predetermined TS packet. If recognition information related information is set at a TS packet level, the recognition information related information extractor 230 or 330 may control a TS packet depacketizer 1520 to extract recognition information insertion information 1525 from the TS packet. Since the recognition information insertion information 1525 is set to ‘0’, 3D user recognition information provided by a content provider does not exist, and since it has been read in advance that displaying of 3D user recognition information is authorized to the display device 1500, the recognition information related information extractor 230 or 330 may control a 2D/3D discrimination device 1550 to extract and read 2D/3D video mode information.

Based on the reading of the 2D/3D discrimination device 1550, the 3D user recognition information extractor 240 or 340 may extract the 3D user recognition information of the display device 1500 from a storage 1560.

The TS packet is formed to an ES stream by passing through the TS packet depacketizer 1520 and a PID filter 1530, and the video data extractor 220 or 320 may extract video data from the ES stream. A video decoder 1540 may restore video content by decoding the video data. The output unit 250 or 350 may output main video content 1580 and 3D user recognition information 1590 to be displayed together on a display screen by synthesizing a video plane 1545 of the restored video content and an OSD plane 1565 of the 3D user recognition information of the display device 1500.

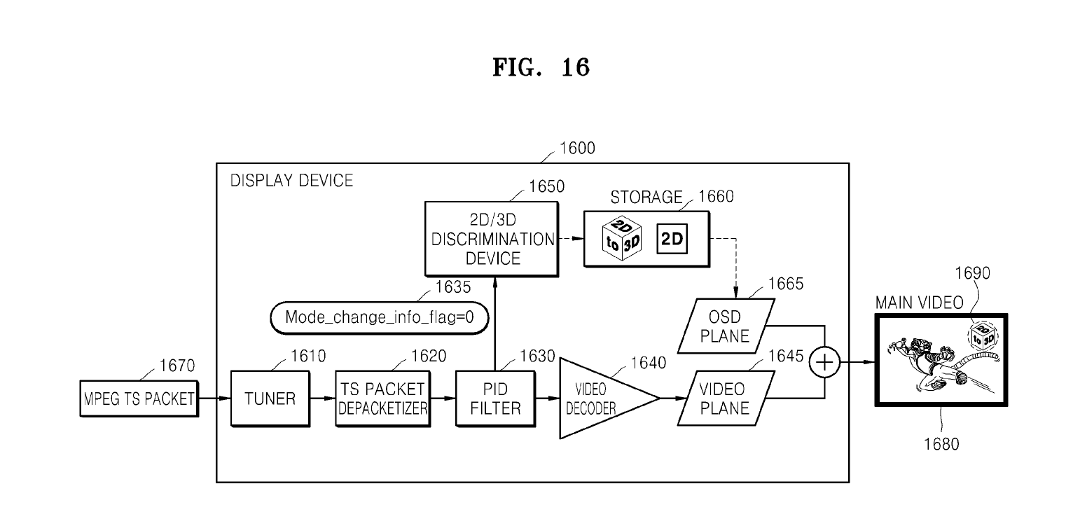

FIG. 16 is a block diagram of a display device 1600 included in the datastream reproducing apparatus 200 and the datastream reproducing apparatus 300, according to another exemplary embodiment.

Referring to FIG. 16, the recognition information related information extractor 230 or 330 may read display rights information from a video datastream generated by the datastream generating apparatus 100 and confirm that displaying of 3D user recognition information is not authorized to an external reproduction device and displaying of 3D user recognition information unique to the display device 1600 on video content is authorized to the display device 1600.

An MPEG TS packet 1670 of the video datastream is input to the display device 1600 and passed through a tuner 1610 to select a predetermined TS packet, and the TS packet is formed to a PES packet by passing through a TS packet depacketizer 1620. If recognition information related information is set at a PES packet level, the recognition information related information extractor 230 or 330 may control a PID filter 1630 to extract recognition information insertion information 1635 from the PES packet.

Since displaying of 3D user recognition information is authorized to the display device 1600, and since 3D user recognition information provided by a content provider does not exist according to the recognition information insertion information 1635 set to ‘0’, the recognition information related information extractor 230 or 330 may control a 2D/3D discrimination device 1650 to read 2D/3D video mode information. Based on the read of the 2D/3D discrimination device 1650, the 3D user recognition information extractor 240 or 340 may extract the 3D user recognition information of the display device 1600 from a storage 1660.

The video data extractor 220 or 320 may extract video data from the ES stream. A video decoder 1640 may restore video content by decoding the video data. The output unit 250 or 350 may output main video content 1680 and 3D user recognition information 1690 to be displayed together on a display screen by synthesizing a video plane 1645 of the restored video content and an OSD plane 1665 of the 3D user recognition information of the display device 1600.

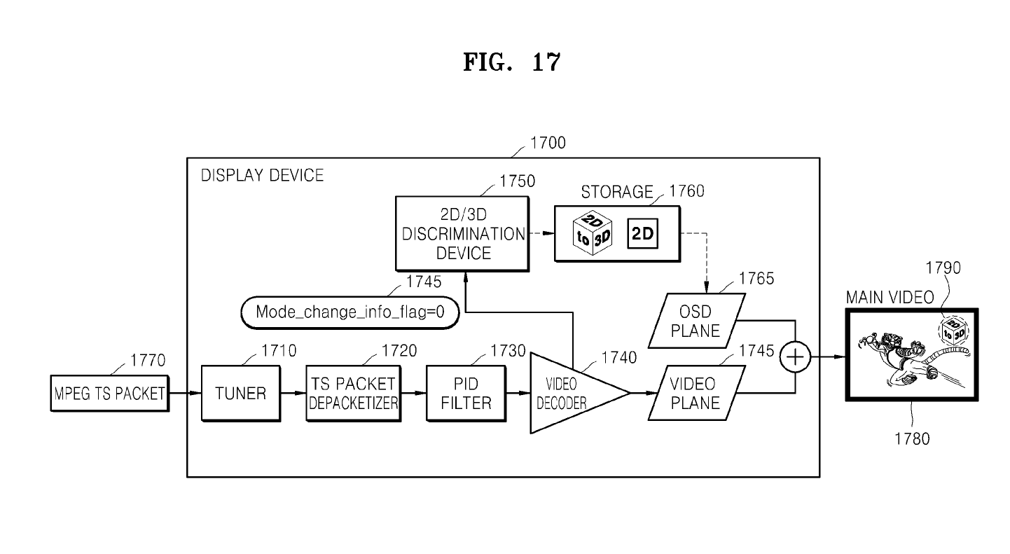

FIG. 17 is a block diagram of a display device 1700 included in the datastream reproducing apparatus 200 and the datastream reproducing apparatus 300, according to another exemplary embodiment.

Referring to FIG. 17, the recognition information related information extractor 230 or 330 may read display rights information from a video datastream generated by the datastream generating apparatus 100 and confirm that displaying of 3D user recognition information is not authorized to an external reproduction device and displaying of 3D user recognition information unique to the display device 1700 on video content is authorized to the display device 1700.

An MPEG TS packet 1770 of the video datastream is input to the display device 1700 and passed through a tuner 1710 to select a predetermined TS packet, and the TS packet is formed to a PES packet by passing through a TS packet depacketizer 1720 and a PID filter 1730. If recognition information related information is set at an ES stream level, the recognition information related information extractor 230 or 330 may control a video decoder 1740 to extract recognition information insertion information 1745 from the ES stream.

Since displaying of 3D user recognition information is authorized to the display device 1700, and since 3D user recognition information provided by a content provider does not exist according to the recognition information insertion information 1745 set to ‘0’, the recognition information related information extractor 230 or 330 may control a 2D/3D discrimination device 1750 to read 2D/3D video mode information. Based on the reading of the 2D/3D discrimination device 1750, the 3D user recognition information extractor 240 or 340 may extract the 3D user recognition information of the display device 1700 from a storage 1760.

The video data extractor 220 or 320 may extract video data from the ES stream. The video decoder 1740 may restore video content by decoding the video data. The output unit 250 or 350 may output main video content 1780 and 3D user recognition information 1790 to be displayed together on a display screen by synthesizing a video plane 1745 of the restored video content and an OSD plane 1765 of the 3D user recognition information of the display device 1700.

If 3D user recognition information is not included in a datastream provided by a content provider and display rights information is set as that displaying of unique 3D user recognition information is authorized to both an external reproduction device and a display device, the priority determiner 260 of the datastream reproducing apparatus 200 may set priority of rights of displaying corresponding unique 3D user recognition information for the external reproduction device and the display device.

The priority determiner 260 may confirm whether the external reproduction device and the display device are capable of displaying the corresponding unique 3D user recognition information. In this case, it is preferable but not necessary that a display apparatus be capable of displaying 3D user recognition information at present regardless of whether the display apparatus is capable of displaying 3D user recognition information or not or whether the display apparatus is incapable of displaying 3D user recognition information at a certain moment or permanently.

If only one of the external reproduction device and the display device is capable of displaying unique 3D user recognition information, the output unit 250 may control a device capable of displaying the unique 3D user recognition information to output a video stream on which the unique 3D user recognition information is displayed by blending the unique 3D user recognition information with video data.

If both the external reproduction device and the display device are capable of displaying unique 3D user recognition information, the priority determiner 260 may determine that priority is granted to one of the devices capable of displaying the unique 3D user recognition information. Accordingly, since only one device to which the priority is granted among the external reproduction device and the display device can display its unique 3D user recognition information, a dual output of 3D user recognition information can be prevented.

FIG. 18 is a schematic diagram of information communication between a source device 1800 and a sink device 1860 based on an HDMI interface.

Referring to FIG. 18, the source device 1800 and the sink device 1860 can exchange information through an HDMI interface, and the HDMI interface may include TMDS channels 1820, 1822, and 1824, a TMDS clock channel 1830, a Display Data Channel (DDC) 1840, and a CEC line 1850.

A transmitter 1810 of the source device 1800 may transmit input video data 1802, input audio data 1804, and auxiliary data through the TMDS channels 1820, 1822, and 1824. The auxiliary data may include control/status data 1806. The control/status data 1806 may output from or input to the transmitter 1810 according to a state of the transmitter 1810.

A receiver 1870 of the sink device 1860 may receive data transmitted from the source device 1800 through the TMDS channels 1820, 1822, and 1824 and output video data 1882, audio data 1884, and control/status data 1886. The control/status data 1886 may be input from another control device to the receiver 1870.

TDMS clocks of the source device 1800 and the sink device 1860 may be synchronized through the TMDS clock channel 1830 between the transmitter 1810 of the source device 1800 and the receiver 1870 of the sink device 1860.

Extended Display Identification Data (EDID) of the source device 1800 may be transmitted to an EDID Random Access Memory (RAM) 1890 of the sink device 1860 through the DDC 1840. The source device 1800 and the sink device 1860 are mutually authenticated by the EDID, and the EDID is a kind of data structure and includes various pieces of information on a monitor. For example, information, such as a manufacturer's name of the monitor, a product type, an EDID version, timing, a screen size, brightness, and pixels, can be exchanged by the EDID.

Control data may be exchanged between the source device 1800 and the sink device 1860 through the CEC line 1850.

The priority determiner 260 may transmit priority determination information indicating mutually set 3D user recognition information through the HDMI interface for connecting an external reproduction device and a display device. The priority determiner 260 may control a recognition information priority display device to set priority determination information and transmit the priority determination information to a recognition information non-priority display device. The priority determination information can be transmitted through at least one of the TMDS channels 1820, 1822, and 1824 and the CEC line 1850 of the HDMI interface.

Data transmitted through the TMDS channels 1820, 1822, and 1824 may include a video data period, a data island period for transmitting voice data and additional data, and a control period for transmitting preamble data. The control period may be transmitted in prior to the video data period.

The preamble data is composed of 4 bits as shown in Table 7.

TABLE 7

| Preamble data composed of 4 bits | | | | Subsequent |
|---|---|---|---|---|
| CTL0 | CTL1 | CTL2 | CTL3 | data period |
| 1 | 0 | 0 | 0 | Video data period |
| 1 | 0 | 1 | 0 | Data island period |

According to Table 7, the last bit CTL3 of the preamble data is not associated with whether a data period following the control period of the preamble data is a video data period or a data island period. Thus, the priority determiner 260 may set priority determination information by using the last bit CTL3 of preamble data.

For example, if a video data period is transmitted consecutively to a control period in which preamble data is transmitted, the priority determiner 260 may set the last bit CTL3 of the preamble data to ‘0’ or ‘1’ that is a value indicating priority determination information.

Control data of the CEC line 1850 can be defined with an opcode. Table 8 shows an example in which the priority determiner 260 sets 3D user recognition information by using an opcode.

TABLE 8

| | | Opcode | | Parameter |
|---|---|---|---|---|
| Opcode | Value | function | Parameter | function |
| <Set User | 0x77 | 3D user | Address of a device | 3D user |
| Information> | | recognition | having no priority | recognition |
| | | information | of displaying 3D | information |
| | | setup | user recognition | display |
| | | | information | rights setup |

In Table 8, 0x77 to 0xFF among opcode values of the control data of the CEC line 1850 are reserved values. Thus, the priority determiner 260 may set an opcode for setting priority determination information by using a reserved value. Referring to Table 8, the priority determiner 260 may define the control data of the CEC line 1850 with an opcode for indicating information for controlling 3D user recognition information and set an address of a device for receiving priority determination information and control data as an operand. The device for receiving the control data is a recognition information non-priority display device and is a device of which rights of displaying unique 3D user recognition information is limited by the priority determination information.

The recognition information related information extractor 230 or 330 of the datastream reproducing apparatus 200 may extract recognition information insertion information and display rights information from a received datastream. It is confirmed based on the recognition information insertion information that 3D user recognition information provided by a content provider does not exist, and it is confirmed based on the display rights information that display rights are granted to both an external reproduction device and a display device.

The priority determiner 260 determines whether each of the external reproduction device and the display device is capable of displaying its unique 3D user recognition information. If both the external reproduction device and the display device are capable of displaying unique 3D user recognition information, the priority determiner 260 may grant priority to one of the external reproduction device and the display device.

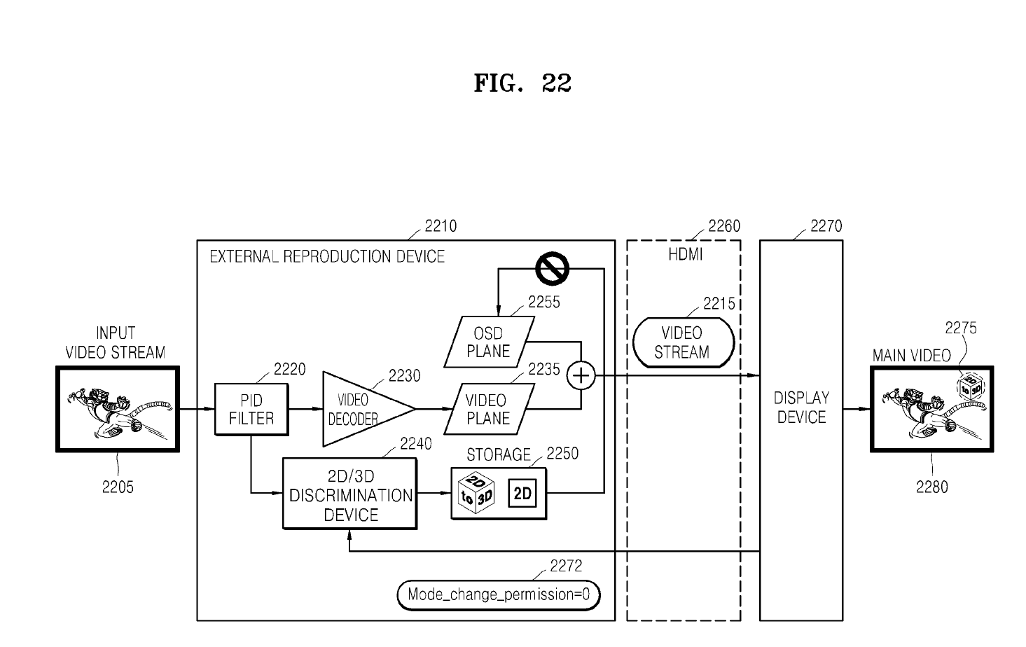

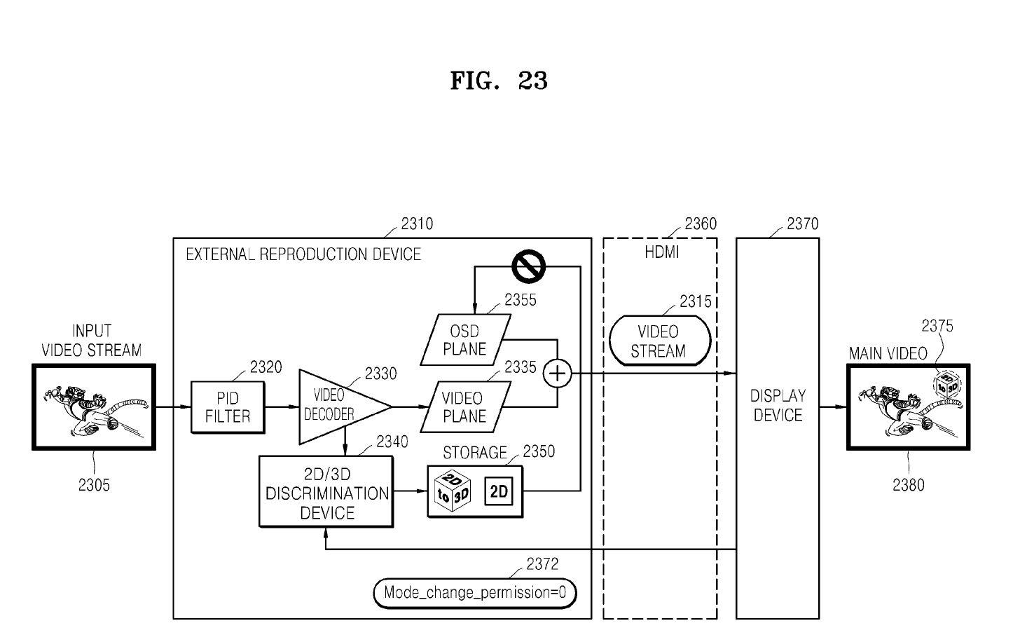

A description will now be made of operation examples (FIGS. 19 to 21) of an external reproduction device and a display device when displaying of 3D user recognition information is authorized to the external reproduction device and operation examples (FIGS. 22 and 23) of the external reproduction device and the display device when displaying of 3D user recognition information is authorized to the display device. Cases where priority determination information according to an exemplary embodiment is updated display rights information when display rights information ‘Mode_change_permission’ of a recognition information non-priority display device is updated by a recognition information priority display device so that display rights do not exist in the display rights information ‘Mode_change_permission’ are disclosed with reference to FIGS. 19 to 23.

FIG. 19 is a first operation example of an external reproduction device 1910 and a display device 1930 according to the datastream reproducing apparatus 200.

Referring to FIG. 19, when the priority determiner 260 grants priority of displaying unique 3D user recognition information to the external reproduction device 1910, the external reproduction device 1910 may output a video stream 1925 obtained by blending the unique 3D user recognition information with video data. Under the control of the priority determiner 260, the external reproduction device 1910 may change a value of display rights information of the display device 1930 to ‘0’ and transmit display right information 1912 updated by the priority determiner 260 to the display device 1930 through an HDMI interface 1920.

Even though recognition information related information is set at a TS packet level, display rights information of the display device 1930 extracted from a TS packet by a TS packet depacketizer 1950 of the display device 1930, which does not have the priority of displaying 3D user recognition information, is not used. Instead, based on the display right information 1912 received from the external reproduction device 1910, an operation of extracting the 3D user recognition information of the display device 1930 through a 2D/3D discrimination device 1980 and a storage 1990 is blocked.

The video data extractor 220 or 320 may control to extract video data from an ES stream formed by passing through a tuner 1940, the TS packet depacketizer 1950, and a PID filter 1960 of the display device 1930. A video decoder 1970 may restore video content by decoding the video data. In the restored video content, the unique 3D user recognition information of the external reproduction device 1910 and the video data are blended.

An OSD plane 1995 does not include at least the 3D user recognition information of the display device 1930. The output unit 250 or 350 may output main video content 1915 and 3D user recognition information 1935 of the external reproduction device 1910 to be displayed together on a display screen by synthesizing a video plane 1975 of the restored video content and the OSD plane 1995.

FIG. 20 is a second operation example of an external reproduction device 2010 and a display device 2030 according to the datastream reproducing apparatus 200.

Referring to FIG. 20, when the priority determiner 260 grants priority of displaying unique 3D user recognition information to the external reproduction device 2010, the external reproduction device 2010 may output a video stream 2025 obtained by blending the unique 3D user recognition information with video data. Under the control of the priority determiner 260, the external reproduction device 2010 may change a value of display rights information of the display device 2030 to ‘0’ and transmit display right information 2012 updated by the priority determiner 260 to the display device 2030 through an HDMI interface 2020.

Even though recognition information related information is set at a PES packet level, display rights information extracted from a PES packet by a PID filter 2060 of the display device 2030, which does not have the priority of displaying 3D user recognition information, is not used. Instead, based on the display right information 2012 of the display device 2030 received from the external reproduction device 2010, an operation of extracting the 3D user recognition information of the display device 2030 through a 2D/3D discrimination device 2080 and a storage 2090 is blocked. Thus, an OSD plane 2095 does not include at least the 3D user recognition information of the display device 2030.

A video decoder 2070 may restore video content by decoding video data extracted from an ES stream formed by passing through a tuner 2040, a TS packet depacketizer 2050, and the PID filter 2060 of the display device 2030. In the restored video content, the unique 3D user recognition information of the external reproduction device 2010 and the video data are blended.

The output unit 250 or 350 may output main video content 2015 and 3D user recognition information 2035 of the external reproduction device 2010 to be displayed together on a display screen. Even though the output unit 250 or 350 synthesizes a video plane 2075 of the restored video content and the OSD plane 2095, the 3D user recognition information of the display device 2030 is not displayed.

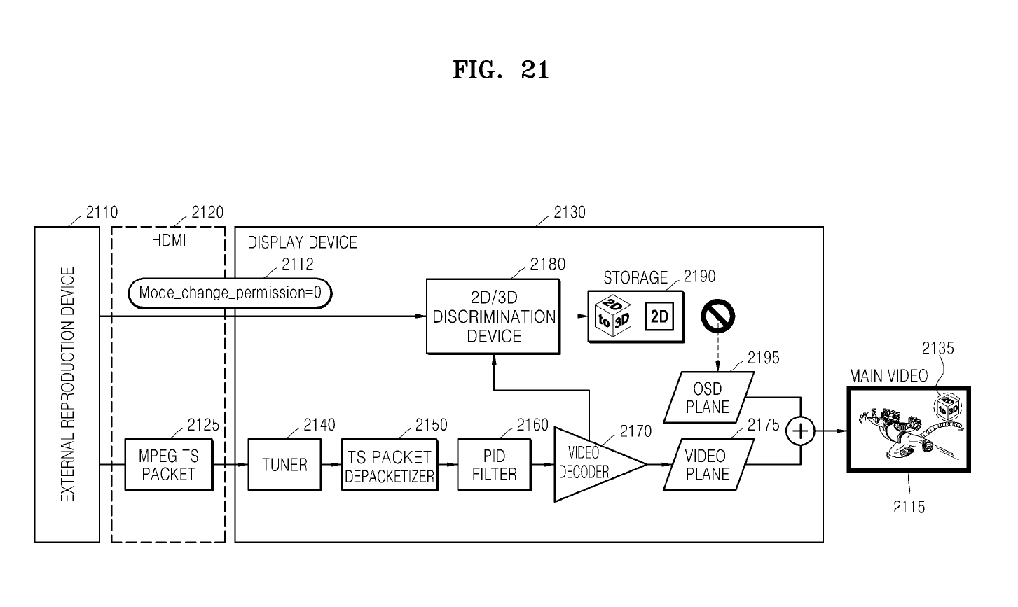

FIG. 21 is a third operation example of an external reproduction device 2110 and a display device 2130 according to the datastream reproducing apparatus 200.

Referring to FIG. 21, when the priority determiner 260 grants priority of displaying unique 3D user recognition information to the external reproduction device 2110, the external reproduction device 2110 may output a video stream 2125 obtained by blending the unique 3D user recognition information with video data. Under the control of the priority determiner 260, the external reproduction device 2110 may transmit display right information 2112 updated for a value of display rights information of the display device 2130 to be set to ‘0’ to the display device 2130 through an HDMI interface 2120.

Even though recognition information related information is set at an ES stream level, display rights information of the display device 2030 extracted from an ES stream by a video decoder 2170 of the display device 2130, which does not have the priority of displaying 3D user recognition information, is not used. Instead, based on display right information 2112 received from the external reproduction device 2110, an operation of extracting the 3D user recognition information of the display device 2130 through a 2D/3D discrimination device 2180 and a storage 2190 is blocked, and an OSD plane 2195 cannot include at least the 3D user recognition information of the display device 2130.

The video decoder 2170 may restore video content by decoding video data extracted from an ES stream formed by passing through a tuner 2140, a TS packet depacketizer 2150, and a PID filter 2160 of the display device 2130. In the restored video content, the unique 3D user recognition information of the external reproduction device 2110 and the video data are blended.

The output unit 250 or 350 may output main video content 2115 and 3D user recognition information 2135 of the external reproduction device 2110 to be displayed together on a display screen. Even though the output unit 250 or 350 synthesizes a video plane 2175 of the restored video content and the OSD plane 2195, the 3D user recognition information of the display device 2130 is not displayed.

FIG. 22 is a fourth operation example of an external reproduction device 2210 and a display device 2270 according to the datastream reproducing apparatus 200.

Referring to FIG. 22, when the priority determiner 260 grants priority of displaying unique 3D user recognition information to the display device 2270, under the control of the priority determiner 260, the display device 2270 may change a value of display rights information of the external reproduction device 2210 to ‘0’ and transmit display right information 2272 updated by the priority determiner 260 to the external reproduction device 2210 through an HDMI interface 2260.

Even though recognition information related information is set at a TS packet level or a PES packet level, display rights information of the external reproduction device 2210 extracted from an input datastream 2205 by a PID filter 2220 of the external reproduction device 2210, which does not have the priority of displaying 3D user recognition information, is not used. Instead, based on display right information 2272 received from the display device 2270, an operation of extracting the 3D user recognition information of the external reproduction device 2210 through a 2D/3D discrimination device 2240 and a storage 2250 of the external reproduction device 2210 is blocked.

A video decoder 2230 of the external reproduction device 2210 may restore video content by decoding video data extracted from an ES stream formed by passing through the PID filter 2220. Since an OSD plane 2255 does not include at least the 3D user recognition information of the external reproduction device 2210, even though the output unit 250 or 350 outputs a video stream 2215 by synthesizing a video plane 2235 of the restored video content and the OSD plane 2255, the video stream 2215 does not include the unique 3D user recognition information of the external reproduction device 2210.

The display device 2270 may receive the video stream 2215 from the external reproduction device 2210 and reproduce main video content 2280 and unique 3D user recognition information 2275 to be displayed together on a display screen by blending and outputting the main video content 2280 and the unique 3D user recognition information 2275 based on the priority of display rights.

FIG. 23 is a fifth operation example of an external reproduction device 2310 and a display device 2370 according to the datastream reproducing apparatus 200.

Referring to FIG. 23, when the priority determiner 260 grants priority of displaying unique 3D user recognition information to the display device 2370, under the control of the priority determiner 260, the display device 2370 may change a value of display rights information of the external reproduction device 2310 to ‘0’ and transmit display right information 2372 updated by the priority determiner 260 to the external reproduction device 2310 through an HDMI interface 2360.

Even though recognition information related information is set at an ES stream level, display rights information of the external reproduction device 2310 extracted from an ES stream of an input datastream 2305 by a video decoder 2330 of the external reproduction device 2310, which does not have the priority of displaying 3D user recognition information, is not used. Instead, based on display right information 2372 received from the display device 2370, an operation of extracting the 3D user recognition information of the external reproduction device 2310 through a 2D/3D discrimination device 2340 and a storage 2350 of the external reproduction device 2310 is blocked.

The video decoder 2330 of the external reproduction device 2310 may restore video content by decoding video data extracted from an ES stream formed by passing through a PID filter 2320. Since an OSD plane 2355 does not include at least the 3D user recognition information of the external reproduction device 2310, even though the output unit 250 or 350 outputs a video stream 2315 by synthesizing a video plane 2335 of the restored video content and the OSD plane 2355, the video stream 2315 does not include the unique 3D user recognition information of the external reproduction device 2310.

The display device 2370 may receive the video stream 2315 from the external reproduction device 2310 and reproduce main video content 2380 and unique 3D user recognition information 2375 to be displayed together on a display screen by blending and outputting the main video content 2380 and the unique 3D user recognition information 2375 based on the priority of display rights.

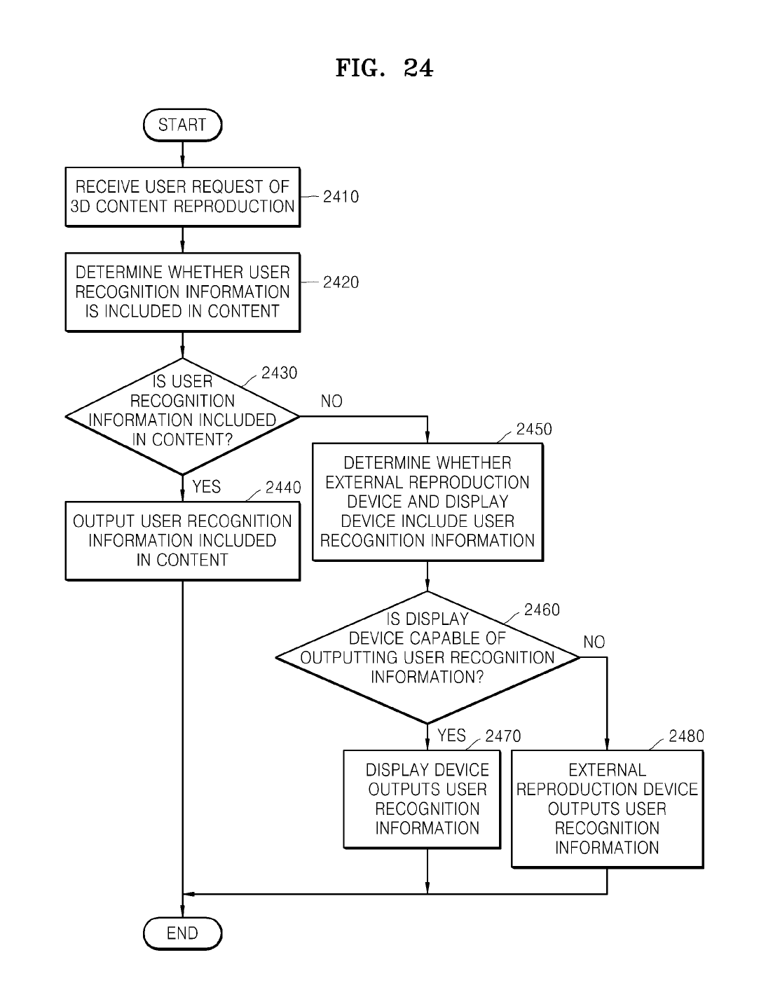

FIG. 24 is a flowchart of an operation for displaying 3D user recognition information in the datastream reproducing apparatus 200.

Referring to FIG. 24, the datastream reproducing apparatus 200 receives a reproduction request of 3D video content from a user in operation 2410. While reproducing video content, a change between the 2D reproduction mode and the 3D reproduction mode may occur. In this case, it is determined in operation 2420 whether the datastream reproducing apparatus 200 can display 3D user recognition information on a display screen.

In operation 2430, the recognition information related information extractor 230 determines based on recognition information insertion information whether the video content includes 3D user recognition information provided by a content provider. The recognition information related information extractor 230 may extract recognition information related information from at least one of a TS packet, a PES packet, and an ES stream of a video datastream received by the receiver, and the recognition information related information includes the recognition information insertion information.

If the video content includes the 3D user recognition information provided by the content provider, the output unit 250 displays the 3D user recognition information provided by the content provider on a display screen together with the video content in operation 2440.

If the video content does not include the 3D user recognition information provided by the content provider, the recognition information related information extractor 230 confirms display rights information of an external reproduction device and a display device and determines whether each of the external reproduction device and the display device includes its unique 3D user recognition information, in operation 2450.

Even though both the external reproduction device and the display device can output unique 3D user recognition information, there is an embodiment in which it is initially set that one of the external reproduction device and the display device has priority compared with the other one. For example, if display rights are granted to both the external reproduction device and the display device having unique 3D user recognition information, the priority determiner 260 determines in operation 2460 whether the display device can output the unique 3D user recognition information on a display screen.

If the display device can output the unique 3D user recognition information, the display device outputs the unique 3D user recognition information in operation 2470. If the display device cannot output its unique 3D user recognition information, the external reproduction device preferably outputs its unique 3D user recognition information on the display screen in operation 2480. However, the priority of display rights between the external reproduction device and the display device can be variably set.

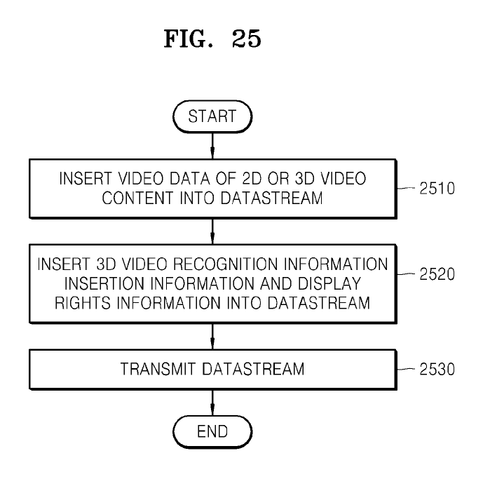

FIG. 25 is a flowchart of a datastream generating method for displaying 3D user recognition information according to an exemplary embodiment.

Referring to FIG. 25, in operation 2510, video data of 2D video content or 3D video content is inserted into a datastream. 3D user recognition information provided by a content provider may be inserted together with the video data.

In operation 2520, recognition information insertion information indicating whether 3D user recognition information including a mark used for a user to recognize that a 3D video is being reproduced is inserted in the datastream and display rights information indicating whether displaying of 3D user recognition information unique to a reproduction device is authorized are inserted into the datastream. Recognition information related information including the recognition information insertion information and the display rights information can be inserted into at least one of an ES stream, a PES packet, and a TS packet of the datastream.

In operation 2530, the datastream into which the video data and the recognition information related information are inserted is transmitted.

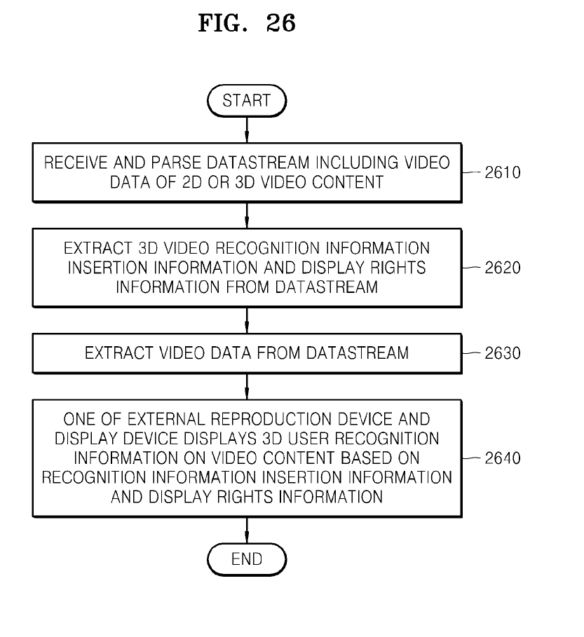

FIG. 26 is a flowchart of a datastream reproducing method for displaying 3D user recognition information according to an exemplary embodiment.

Referring to FIG. 26, in operation 2610, a datastream including video data of 2D video content or 3D video content is received and parsed.

In operation 2620, recognition information insertion information indicating whether 3D user recognition information is inserted in the datastream and display rights information of an external reproduction device and a display device are extracted from the datastream. The recognition information insertion information and the display rights information can be extracted from at least one of an ES stream level, a PES packet level, and a TS packet level of the datastream.

In operation 2630, the video data is extracted from the parsed datastream. Based on the recognition information insertion information extracted in operation 2620, if the received datastream includes 3D user recognition information provided by a content provider, the 3D user recognition information may be extracted from the parsed datastream.

In operation 2640, based on the extracted recognition information insertion information and display rights information, one of an external reproduction device and a display device can reproduce the 3D user recognition information provided by the content provider on a display screen together with the video content or reproduce unique 3D user recognition information so as to display the unique 3D user recognition information on the video content.

If it is confirmed based on the recognition information insertion information that the 3D user recognition information provided by the content provider is not inserted into the datastream and it is confirmed based on the display rights information that displaying of unique 3D user recognition information is authorized to each of the external reproduction device and the display device, priority of rights of displaying the unique 3D user recognition information on the video content between the external reproduction device and the display device may be determined, and a device having the priority of display rights among the external reproduction device and the display device may output the datastream on which the unique 3D user recognition information is displayed.

If the 3D user recognition information is provided by the content provider, and if the external reproduction device or the display device can output the unique 3D user recognition information, the datastream generating apparatus 100 may set the recognition information insertion information indicating whether the 3D user recognition information provided by the content provider is inserted in the datastream together with the video content and the display rights information indicating whether a display apparatus has rights of displaying the unique 3D user recognition information on the display screen and transmit the recognition information insertion information and the display rights information together with the video content so that a plurality of pieces of 3D user recognition information are not displayed simultaneously on the display screen.

The datastream reproducing apparatus 200 or 300 may extract the recognition information insertion information and the display rights information from the datastream transmitted from the datastream generating apparatus 100, and selectively output the plurality of pieces of 3D user recognition information based on the extracted information so that the plurality of pieces of 3D user recognition information are not displayed simultaneously on the display screen.

Accordingly, a phenomenon of outputting a plurality of 3D user recognition information simultaneously on the video content or outputting depth perception in a reversal way can be prevented, and the user can comfortably enjoy watching the video content by recognizing a change between the 2D reproduction mode and the 3D reproduction mode in advance. Due to the facility to comfortably watch 3D video content, users' demand for 3D video content will increase, thereby enhancing the spread of 3D video content. Accordingly, the spread of display apparatuses capable of reproducing the 3D video content can be more accelerated.

The exemplary embodiments can be written as computer programs and can be implemented in general-use digital computers that execute the programs using a non-transitory computer readable recording medium. Examples of the non-transitory computer readable recording medium include magnetic storage media (e.g., ROM, floppy disks, hard disks, etc.) and optical recording media (e.g., CD-ROMs, or DVDs).

While the inventive concept has been particularly shown and described with reference to exemplary embodiments thereof, it will be understood by those skilled in the art that various changes in form and details may be made therein without departing from the spirit and scope of the inventive concept as defined by the appended claims. The exemplary embodiments should be considered in descriptive sense only and not for purposes of limitation. Therefore, the scope of the inventive concept is defined not by the detailed description of the exemplary embodiments but by the appended claims, and all differences within the scope will be construed as being included in the inventive concept.

What is claimed is:

1. A method of generating a datastream including two-dimensional (2D) video content or three-dimensional (3D) video content, the method comprising:
inserting video data of the 2D video content or the 3D video content into the datastream;
inserting into the datastream recognition information insertion information indicating whether 3D user recognition information including a mark used for a user to recognize that a 3D video is being reproduced is inserted in the datastream and display rights information indicating whether displaying of the 3D user recognition information unique to a reproduction device is authorized; and
transmitting the datastream.

2. The method of claim 1, wherein the inserting of the recognition information insertion information and the display rights information comprises inserting the recognition information insertion information and the display rights information into one of a Transport Stream (TS) packet, a Packetized Elementary Stream (PES) packet, and an Elementary Stream (ES) stream of the datastream.

3. The method of claim 2, wherein the inserting into the datastream of the recognition information insertion information and the display rights information comprises allocating Packet IDentifier (PID) information of a header field of a predetermined TS packet as one of reserved values and inserting a video descriptor including the recognition information insertion information and the display rights information into a data field of the predetermined TS packet.

4. The method of claim 2, wherein the inserting of the recognition information insertion information and the display rights information comprises, if determined that reserved values, which are allocated to PID information of a header field of a TS packet, correspond to combinations of 2D/3D video characteristics of the video data inserted into the datastream, and the recognition information insertion information and the display rights information on a one-to-one basis, allocating reserved values corresponding to combinations of current 2D/3D video characteristics, and the recognition information insertion information and the display rights information to PID information of TS packets of the datastream.

5. The method of claim 2, wherein the inserting of the recognition information insertion information and the display rights information comprises inserting the recognition information insertion information and the display rights information into a PES private data field, which is a lower field of an optional header field of a predetermined PES packet among PES packets of the datastream.

6. The method of claim 2, wherein the inserting of the recognition information insertion information and the display rights information comprises inserting the recognition information insertion information and the display rights information into a user data field, which is a lower field of an extension and user field of an ES stream of the datastream.

7. The method of claim 1, wherein, if the recognition information insertion information indicates that the 3D user recognition information is included in the datastream, the display rights information is set so that displaying of the unique 3D user recognition information is not authorized to the reproduction device.

8. The method of claim 1, further comprising inserting the 3D user recognition information provided by a content provider into an auxiliary ES stream besides a main ES stream into which the video data is inserted in the datastream,
wherein the main ES stream and the auxiliary ES stream are multiplexed to one stream.

9. The method of claim 1, further comprising inserting the 3D user recognition information provided by a content provider into an ES stream separate from an ES stream into which the video data is inserted in the datastream.

10. The method of claim 1, further comprising inserting the 3D user recognition information provided by a content provider as additional data of an ES stream into which the video data is inserted in the datastream.

11. The method of claim 1, wherein, if the recognition information insertion information is set so that the 3D user recognition information provided by a content provider is not included in the datastream, and if the display rights information is set so that displaying of corresponding unique 3D user recognition information is authorized to two or more reproduction devices, the two or more reproduction devices set priority of rights of displaying the corresponding unique 3D user recognition information.

12. A method of reproducing a datastream, comprising:
receiving and parsing a datastream including video data of two-dimensional (2D) video content or three-dimensional (3D) video content;
extracting from the datastream recognition information insertion information indicating whether 3D user recognition information including a mark used for a user to recognize that a 3D video is being reproduced is inserted in the datastream and display rights information indicating whether displaying of 3D user recognition information unique to an external reproduction device and a display device is authorized;
extracting the video data from the parsed datastream; and
displaying by one of the external reproduction device and the display device one of the 3D user recognition information and the unique 3D user recognition information on the video content based on the extracted recognition information insertion information and display rights information.

13. The method of claim 12, wherein the extracting of the recognition information insertion information and the display rights information comprises extracting the recognition information insertion information and the display rights information from one of a Transport Stream (TS) packet, a Packetized Elementary Stream (PES) packet, and an Elementary Stream (ES) stream of the datastream.

14. The method of claim 13, wherein the extracting of the recognition information insertion information and the display rights information comprises extracting a video descriptor including the recognition information insertion information and the display rights information from a data field of a TS packet of Packet IDentifier (PID) information allocated as one of reserved values among TS packets of the datastream.

15. The method of claim 13, wherein the extracting of the recognition information insertion information and the display rights information comprises, if determined that reserved values, which are allocated to PID information of a header field of a TS packet, correspond to combinations of 2D/3D video characteristics of the video data inserted into the datastream, and the recognition information insertion information and the display rights information on a one-to-one basis, reading current 2D/3D video characteristics, and the recognition information insertion information and the display rights information based on PID information of TS packets of the datastream.

16. The method of claim 13, wherein the extracting of the recognition information insertion information and the display rights information comprises extracting the recognition information insertion information and the display rights information from a PES private data field, which is a lower field of an optional header field of a predetermined PES packet among PES packets of the datastream.

17. The method of claim 13, wherein the extracting of the recognition information insertion information and the display rights information comprises extracting the recognition information insertion information and the display rights information from a user data field, which is a lower field of an extension and user field of an ES stream of the datastream.

18. The method of claim 12, wherein the displaying of the 3D user recognition information comprises:
confirming based on the recognition information insertion information that the 3D user recognition information provided by a provider of the video content is not inserted in the datastream and confirming based on the display rights information that displaying of the unique 3D user recognition information on the video content is authorized to the external reproduction device; and
outputting by the external reproduction device a video stream on which the 3D user recognition information is displayed, by blending the 3D user recognition information unique to the external reproduction device and the video data.

19. The method of claim 12, wherein the displaying of the 3D user recognition information comprises:
confirming based on the recognition information insertion information that the 3D user recognition information provided by a provider of the video content is not inserted in the datastream and confirming based on the display rights information that displaying of the unique 3D user recognition information on the video content is authorized to the display device; and
outputting by the display device a video stream on which the 3D user recognition information is displayed, by blending the 3D user recognition information unique to the display device and the video data.

20. The method of claim 12, wherein the displaying of the 3D user recognition information comprises:
confirming based on the recognition information insertion information that the 3D user recognition information provided by a provider of the video content is not inserted in the datastream and confirming based on the display rights information that displaying of the unique 3D user recognition information on the video content is authorized to the external reproduction device and the display device;
determining priority of rights of displaying the unique 3D user recognition information on the video content between the external reproduction device and the display device; and
outputting a video stream on which the 3D user recognition information is displayed, based on the priority of display rights between the external reproduction device and the display device.

21. The method of claim 20, wherein the outputting of the video stream on which the 3D user recognition information is displayed comprises: determining a display capability of each of the external reproduction device and the display device for displaying each unique 3D user recognition information and outputting by a device having the display capability the video stream on which the 3D user recognition information is displayed by blending the corresponding unique 3D user recognition information with the video data as a result of the determining the display capability.

22. The method of claim 20, wherein the determining of the priority comprises: determining a display capability of each of the external reproduction device and the display device for displaying each unique 3D user recognition information and, if both the external reproduction device and the display device have the display capability, determining the priority.

23. The method of claim 22, wherein the determining of the priority comprises determining the priority between the external reproduction device and the display device based on a user's input or an initial setup and setting by a device having the priority determination information and transmitting the priority determination information to a device having no priority.

24. The method of claim 22, wherein the determining of the priority comprises exchanging 3D user recognition information processing prohibition information through an interface supporting data transmission/reception between the external reproduction device and the display device.

25. The method of claim 24, wherein the determining of the priority comprises, if data between the external reproduction device and the display device is exchanged through a High-Definition Multimedia Interface (HDMI) interface, transmitting the priority determination information through one channel of a Transition Minimized Differential Signaling (TMDS) channel and a Consumer Electronics Control (CEC) line.

26. The method of claim 25, wherein the determining of the priority comprises, if a video data period is transmitted next to a control period of the TMDS channel, allocating the 3D user recognition information processing prohibition information to the last bit of preamble data transmitted in the control period and transmitting the preamble data to the other device.

27. The method of claim 25, wherein the determining of the priority comprises inserting an operation code (opcode) for indicating information for controlling the 3D user recognition information and an address of the other device receiving the priority determination information and control data of the CES line into the control data of the CES line and transmitting the control data to the other device through the CES line.

28. The method of claim 23, wherein the displaying of the 3D user recognition information comprises restricting a blending function of the corresponding unique 3D user recognition information and the video data for a device which has received the priority determination information

29. The method of claim 23, wherein the displaying of the 3D user recognition information comprises changing display rights information for a device which has received the priority determination information so that the display rights information indicates no display rights.

30. The method of claim 12, wherein the displaying of the 3D user recognition information comprises, if confirmed based on the recognition information insertion information that the 3D user recognition information provided by a provider of the video content is inserted in the datastream, outputting the video data on which the 3D user recognition information is displayed, extracted from the datastream.

31. The method of claim 12, wherein the displaying of the 3D user recognition information comprises:
if confirmed based on the recognition information insertion information that the 3D user recognition information provided by a provider of the video content is inserted in the datastream, extracting the 3D user recognition information from the datastream; and
blending and outputting the extracted 3D user recognition information and the extracted video data.

32. The method of claim 31, wherein the extracting of the 3D user recognition information comprises extracting the 3D user recognition information from an auxiliary ES stream besides a main ES stream into which the video data is inserted in the datastream, and
the main ES stream and the auxiliary ES stream are demultiplexed from one stream.

33. The method of claim 31, wherein the extracting of the 3D user recognition information comprises extracting the 3D user recognition information from an ES stream separate from an ES stream into which the video data is inserted in the datastream.

34. The method of claim 31, wherein the extracting of the 3D user recognition information comprises extracting the 3D user recognition information as additional information of an ES stream into which the video data is inserted, in the datastream.

35. An apparatus for generating a datastream including two-dimensional (2D) video content or three-dimensional (3D) video content, the apparatus comprising:
a video data inserter which inserts video data of the 2D video content or the 3D video content into the datastream;
a 3D user recognition information inserter which inserts into the datastream 3D user recognition information including a mark used for a user to recognize that a 3D video is being reproduced;
a recognition information related information inserter which inserts into the datastream recognition information insertion information indicating whether the 3D user recognition information is inserted in the datastream and display rights information indicating whether displaying of 3D user recognition information unique to a reproduction device is authorized; and
a transmitter which transmits the datastream.

36. The apparatus of claim 35, wherein the 3D user recognition information inserter inserts the recognition information insertion information and the display rights information into one of a Transport Stream (TS) packet, a Packetized Elementary Stream (PES) packet, and an Elementary Stream (ES) stream of the datastream.

37. An apparatus for reproducing a datastream, the apparatus comprising:
a receiver which receives and parses a datastream including video data of 2D video content or 3D video content;
a recognition information related information extractor which extracts from the datastream recognition information insertion information indicating whether 3D user recognition information including a mark used for a user to recognize that a 3D video is being reproduced is inserted in the datastream and display rights information indicating whether displaying of 3D user recognition information unique to an external reproduction device and a display device is authorized;
a 3D user recognition information extractor which extracts the 3D user recognition information from the datastream based on the recognition information insertion information;
a video data extractor which extracts the video data from the parsed datastream; and
an output unit which displays via one of the external reproduction device and the display device one of the 3D user recognition information and the unique 3D user recognition information on the video content based on the extracted recognition information insertion information and display rights information.

38. The apparatus of claim 37, wherein each of the external reproduction device and the display device comprises a priority determiner for determining priority of rights of displaying the unique 3D user recognition information on the video content between the external reproduction device and the display device if confirmed based on the recognition information insertion information that the 3D user recognition information provided by a provider of the video content is not inserted in the datastream and if confirmed based on the display rights information that displaying of the unique 3D user recognition information on the video content is authorized to the external reproduction device and the display device, and
the output unit outputs a video stream on which the 3D user recognition information is displayed, based on the priority of display rights between the external reproduction device and the display device.

39. An apparatus for reproducing a datastream, the apparatus comprising:
a receiver which receives and parses a datastream including video data of two-dimensional (2D) video content or three-dimensional (3D) video content;
a recognition information related information extractor which extracts from the datastream recognition information insertion information indicating whether 3D user recognition information including a mark used for a user to recognize that a 3D video is being reproduced is inserted in the datastream and display rights information indicating whether displaying of 3D user recognition information unique to an external reproduction device and a display device is authorized;
a 3D user recognition information extractor which extracts the 3D user recognition information from the datastream based on the recognition information insertion information;
a video data extractor which extracts the video data from the parsed datastream; and
an output unit which displays, via the display device, one of the 3D user recognition information and the unique 3D user recognition information on the video content based on the extracted recognition information insertion information and display rights information.

40. A non-transitory computer readable recording medium having recorded thereon a computer readable program for executing the method of claim 1.

41. A non-transitory computer readable recording medium having recorded thereon a computer readable program for executing the method of claim 12.

42. A method of generating a datastream including two-dimensional (2D) video content or three-dimensional (3D) video content, the method comprising:
inserting video data of the 2D video content or the 3D video content into the datastream;
inserting into the datastream information for displaying an icon illustrating a dimension of a video being reproduced or to be reproduced and for authorizing a reproduction device to display the icon illustrating the dimension of the video being reproduced; and
transmitting the datastream.
